(19) United States
(12) Patent Application Publication
(10) Pub. No.: US 2017/0116500 A1
(43) Pub. Date: Apr. 27, 2017

(54) IMAGE PROCESSING APPARATUS, IMAGE PROCESSING METHOD AND IMAGE PROCESSING PROGRAM

(71) Applicant: Kabushiki Kaisha Toshiba, Tokyo (JP)

(72) Inventors: Kazunori IMOTO, Kawasaki Kanagawa (JP); Yojiro TONOUCHI, Inagi Tokyo (JP); Kaoru SUZUKI, Yokohama Kanagawa (JP); Osamu YAMAGUCHI, Yokohama Kanagawa (JP)

(21) Appl. No.: 15/249,267

(22) Filed: Aug. 26, 2016

(30) Foreign Application Priority Data
Oct. 27, 2015 (JP) 2015-210875

(51) Int. Cl. G06K 9/72; G06T 7/40; G06K 9/46

(52) U.S. Cl. CPC G06K 9/72; G06K 9/4604; G06T 7/408; G06K 2209/01

(57) ABSTRACT

According to one embodiment, an image processing apparatus includes an acquiring unit and a processing unit. The acquiring unit acquires an image including a plurality of character strings. The processing unit carries out a detecting operation, a receiving operation, an extracting operation, and a generating operation. The detecting operation includes detecting a plurality of image regions concerning the plurality of character strings from the image. The receiving operation includes receiving an input of coordinate information concerning coordinates in the image. The extracting operation includes extracting, out of the plurality of image regions, designated regions designated by the coordinate information. The generating operation includes generating, on the basis of the coordinate information, corrected regions obtained by correcting at least one of a number and a size of the designated regions.

### CROSS-REFERENCE TO RELATED APPLICATIONS

This application is based upon and claims the benefit of priority from Japanese Patent Application No. 2015-210875, filed on Oct. 27, 2015; the entire contents of which are incorporated herein by reference.

### FIELD

Embodiments described herein relate generally to an image processing apparatus, an image processing method and an image processing program.

### BACKGROUND

There is an image processing apparatus that acquires an image of a label for management or the like stuck to an article and reads characters corresponding to items of the label for management. Character data read by the image processing apparatus is registered as, for example, data for management. In order to accurately read characters in the image processing apparatus, a reading region including the characters is designated. Complicated operation is necessary for the designation of the reading region. In the image processing apparatus, it is demanded that the characters can be efficiently read with simple operation.

### BRIEF DESCRIPTION OF THE DRAWINGS

FIG. 1 is a block diagram illustrating an image processing apparatus according to a first embodiment;

FIG. 2A and FIG. 2B are schematic views illustrating an article and an image according to the first embodiment;

FIG. 3A and FIG. 3B are diagrams illustrating the operation of the detecting unit according to the first embodiment;

FIG. 4 is a flowchart for describing an operation example of the detecting unit according to the first embodiment;

FIG. 5A and FIG. 5B are diagrams illustrating the operation of the receiving unit according to the first embodiment;

FIG. 6 is a flowchart for describing an operation example of the receiving unit according to the first embodiment;

FIG. 7A to FIG. 7C are diagrams illustrating the operation of the extracting unit according to the first embodiment;

FIG. 8 is a flowchart for describing an operation example of the extracting unit according to the first embodiment;

FIG. 9A and FIG. 9B are diagrams illustrating the operation of the generating unit according to the first embodiment;

FIG. 10 is a flowchart for describing an operation example of the generating unit according to the first embodiment;

FIG. 11 is a diagram illustrating the classification table 25;

FIG. 12 is a schematic view illustrating an image according to a second embodiment;

FIG. 13A to FIG. 13C are diagrams illustrating the operation of the detecting unit according to the second embodiment;

FIG. 14 is a flowchart for describing an operation example of the detecting unit according to the second embodiment;

FIG. 15A and FIG. 15B are diagrams illustrating the operation of the receiving unit according to the second embodiment;

FIG. 16 is a flowchart for describing an operation example of the receiving unit according to the second embodiment;

FIG. 17A to FIG. 17C are diagrams illustrating the operation of the extracting unit according to the second embodiment;

FIG. 18 is a flowchart for describing an operation example of the extracting unit according to the second embodiment;

FIG. 19A and FIG. 19B are diagrams illustrating the operation of the generating unit according to the second embodiment;

FIG. 20 is a flowchart for describing an operation example of the generating unit according to the second embodiment;

FIG. 21 is a schematic view illustrating an image according to a third embodiment;

FIG. 22A to FIG. 22C are diagrams illustrating the operation of the detecting unit according to a third embodiment;

FIG. 23 is a flowchart for describing an operation example of the detecting unit according to the third embodiment;

FIG. 24A and FIG. 24B are diagrams illustrating the operation of the receiving unit according to the third embodiment;

FIG. 25 is a flowchart for describing an operation example of the receiving unit according to the second embodiment;

FIG. 26A to FIG. 26C are diagrams illustrating the operation of the extracting unit according to the third embodiment;

FIG. 27 is a flowchart for describing an operation example of the extracting unit according to the third embodiment;

FIG. 28A and FIG. 28B are diagrams illustrating the operation of the generating unit according to the third embodiment;

FIG. 29 is a flowchart for describing an operation example of the generating unit according to the third embodiment;

FIG. 30 is a schematic view illustrating an image according to a fourth embodiment;

FIG. 31A and FIG. 31B are diagrams illustrating the operation of the detecting unit according to the fourth embodiment;

FIG. 32 is a flowchart for describing an operation example of the detecting unit according to the fourth embodiment;

FIG. 33A and FIG. 33B are diagrams illustrating the operation of the receiving unit according to the fourth embodiment;

FIG. 34 is a flowchart for describing an operation example of the receiving unit according to the fourth embodiment;

FIG. 35A to FIG. 35C are diagrams illustrating the operation of the extracting unit according to the fourth embodiment;

FIG. 36 is a flowchart for describing an operation example of the extracting unit according to the fourth embodiment;

FIG. 37A and FIG. 37B are diagrams illustrating the operation of the generating unit according to the fourth embodiment;

FIG. 38 is a flowchart for describing an operation example of the generating unit according to the fourth embodiment;

FIG. 39 is a block diagram illustrating an image processing apparatus according to a fifth embodiment;

FIG. 40 is a schematic view illustrating a screen of a display unit of the image processing apparatus;

FIG. 41 is a schematic view illustrating an image according to a fifth embodiment;

FIG. 42A and FIG. 42B are diagrams illustrating the operation of the detecting unit according to the fifth embodiment;

FIG. 43 is a flowchart for describing an operation example of the detecting unit according to the fifth embodiment;

FIG. 44A and FIG. 44B are diagrams illustrating the operation of the receiving unit according to the fifth embodiment;

FIG. 45 is a flowchart for describing an operation example of the receiving unit according to the fifth embodiment;

FIG. 46A to FIG. 46C are diagrams illustrating the operation of the extracting unit according to the fifth embodiment;

FIG. 47 is a flowchart for describing an operation example of the extracting unit according to the fifth embodiment;

FIG. 48A and FIG. 48B are diagrams illustrating the operation of the generating unit according to the fifth embodiment;

FIG. 49 is a flowchart for describing an operation example of the generating unit according to the fifth embodiment;

FIG. 50 is a schematic view illustrating a screen of the image processing apparatus according to the fifth embodiment;

FIG. 51A and FIG. 51B are diagrams illustrating the operation of the detecting unit according to a sixth embodiment;

FIG. 52 is a flowchart for describing an operation example of the detecting unit according to the sixth embodiment;

FIG. 53A and FIG. 53B are diagrams illustrating the operation of the receiving unit according to the sixth embodiment;

FIG. 54 is a flowchart for describing an operation example of the receiving unit according to the sixth embodiment;

FIG. 55A to FIG. 55C are diagrams illustrating the operation of the extracting unit according to the sixth embodiment;

FIG. 56 is a flowchart for describing an operation example of the extracting unit according to the sixth embodiment;

FIG. 57A and FIG. 57B are diagrams illustrating the operation of the generating unit according to the sixth embodiment;

FIG. 58 is a flowchart for describing an operation example of the generating unit according to the sixth embodiment; and

FIG. 59 is a block diagram illustrating an image processing apparatus according to a seventh embodiment.

### DETAILED DESCRIPTION

According to one embodiment, an image processing apparatus includes an acquiring unit and a processing unit. The acquiring unit acquires an image including a plurality of character strings. The processing unit carries out a detecting operation, a receiving operation, an extracting operation, and a generating operation. The detecting operation includes detecting a plurality of image regions concerning the plurality of character strings from the image. The receiving operation includes receiving an input of coordinate information concerning coordinates in the image. The extracting operation includes extracting, out of the plurality of image regions, designated regions designated by the coordinate information. The generating operation includes generating, on the basis of the coordinate information, corrected regions obtained by correcting at least one of a number and a size of the designated regions.

Various embodiments will be described hereinafter with reference to the accompanying drawings.

The drawings are schematic and conceptual; and the relationships between the thickness and width of portions, the proportions of sizes among portions, etc., are not necessarily the same as the actual values thereof. Further, the dimensions and proportions may be illustrated differently among drawings, even for identical portions.

In the specification and drawings, components similar to those described or illustrated in a drawing thereinabove are marked with like reference numerals, and a detailed description is omitted as appropriate.

### First Embodiment

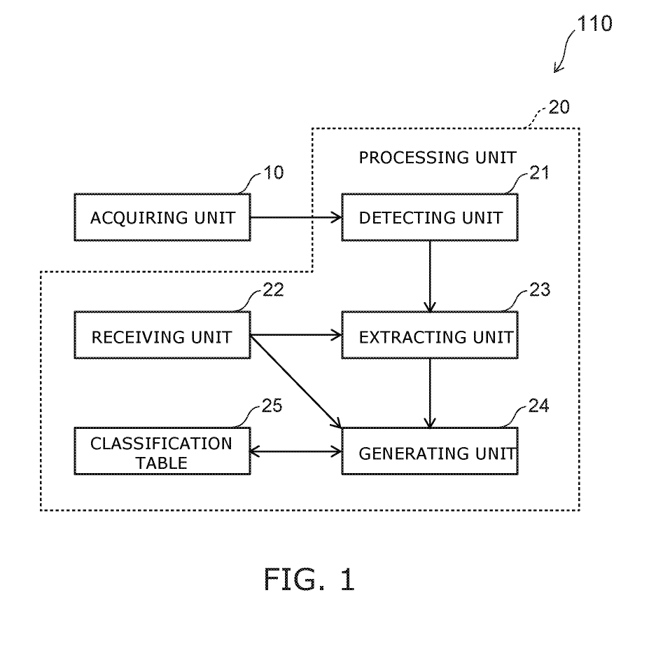

FIG. 1 is a block diagram illustrating an image processing apparatus according to a first embodiment.

An image processing apparatus 110 according to the embodiment includes an acquiring unit 10 and a processing unit 20. As the acquiring unit 10, for example, an input/output terminal is used. The acquiring unit 10 includes an input/output interface that communicates with the outside via wire or radio. As the processing unit 20, for example, an arithmetic device including a CPU (Central Processing Unit) and a memory is used. As a part or all of blocks of the processing unit 20, integrated circuits such as LSIs (Large Scale Integrations) or IC (Integrated Circuit) chip sets can be used. Individual circuits may be used for the blocks or a circuit on which a part or all of the blocks are integrated may be used. The blocks may be integrally provided or a part of the blocks may be separately provided. In each of the blocks, a part of the block may be separately provided. For the integration, not only the LSIs but also dedicated circuits or general-purpose processors may be used.

In the processing unit 20, a detecting unit 21, a receiving unit 22, an extracting unit 23, a generating unit 24, and a classification table 25 are provided. The units are realized as, for example, an image processing program. That is, the image processing apparatus 110 is also realized by using a general-purpose computer apparatus as basic hardware. Functions of units included in the image processing apparatus 110 can be realized by causing a processor mounted on the computer apparatus to execute the image processing program. In this case, the image processing apparatus 110 may be realized by installing the image processing program in the computer apparatus in advance or may be realized by storing the image processing program in a storage medium such as a CD-ROM or distributing the image processing program via a network and installing the image processing program in the computer apparatus as appropriate. The processing unit 20 can be realized by using, as appropriate, a storage medium such as a memory, a hard disk, a CD-ROM, a CD-RW, a DVD-RAM, or a DVD-R incorporated in or externally attached to the computer apparatus.

The image processing apparatus 110 according to the embodiment reads characters corresponding to input items from for example, an image obtained by photographing a label for management stuck to an article. The image processing apparatus 110 detects a plurality of image regions serving as reading regions from the image. Each of the plurality of image regions includes one or more characters. The image processing apparatus 110 extracts, out of the plurality of image regions, designated regions designated by coordinate information corresponding to operation (e.g., pinch-in or pinch-out) by a user. The designated regions are, for example, image regions where characters are excessive or insufficient and desired character strings are not formed among the plurality of image regions. The image processing apparatus 110 generates, on the basis of the coordinate information corresponding to the operation by the user, corrected regions obtained by correcting at least one of the number and the size of the designated regions. The corrected regions are image regions composed of desired character strings formed by correcting the excess or the insufficiency of the characters. Consequently, it is possible to efficiently read characters with simple operation.

That is, the detecting unit 21 carries out a detecting operation. The detecting operation includes detecting a plurality of image regions concerning a plurality of character strings from an image.

The receiving unit 22 carries out a receiving operation. The receiving operation includes receiving an input of coordinate information concerning coordinates in the image. One coordinate or a plurality of coordinates may be present.

The extracting unit 23 carries out an extracting operation. The extracting operation includes extracting, out of the plurality of image regions, designated regions designated by the coordinate information. One designated region or a plurality of designated regions may be extracted.

The generating unit 24 carries out a generating operation. The generating operation includes generating corrected regions obtained by correcting, on the basis of the coordinate information, at least one of the number and the size of the designated regions. One corrected region or a plurality of corrected regions may be generated.

Specific operation examples of the detecting unit 21, the receiving unit 22, the extracting unit 23, and the generating unit 24 are described.

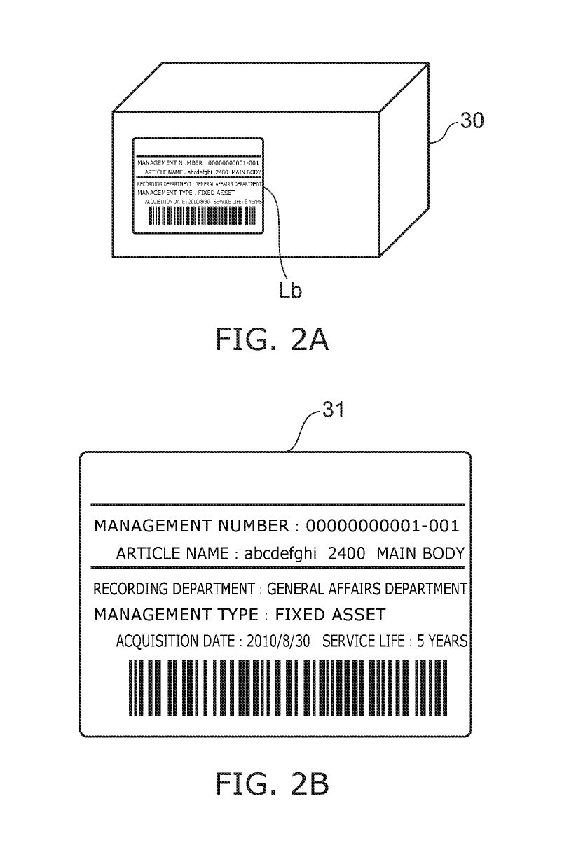

FIG. 2A and FIG. 2B are schematic views illustrating an article and an image according to the first embodiment.

As shown in FIG. 2A, an article 30 is disposed in a real space. A label for management Lb is stuck to the article 30. A plurality of input items are described on the label for management Lb. In the example, a management number, an article name, a recording department, a management type, an acquisition date, and service life respectively correspond to the input items.

As shown in FIG. 2B, the acquiring unit 10 acquires an image 31. The image 31 is, for example, an image obtained by photographing the label for management Lb. The acquiring unit 10 may acquire the image 31 from an image pickup device such as a digital still camera. The acquiring unit 10 may acquire the image 31 from a storage medium such as a HDD (Hard Disk Drive). The image 31 includes a plurality of character strings.

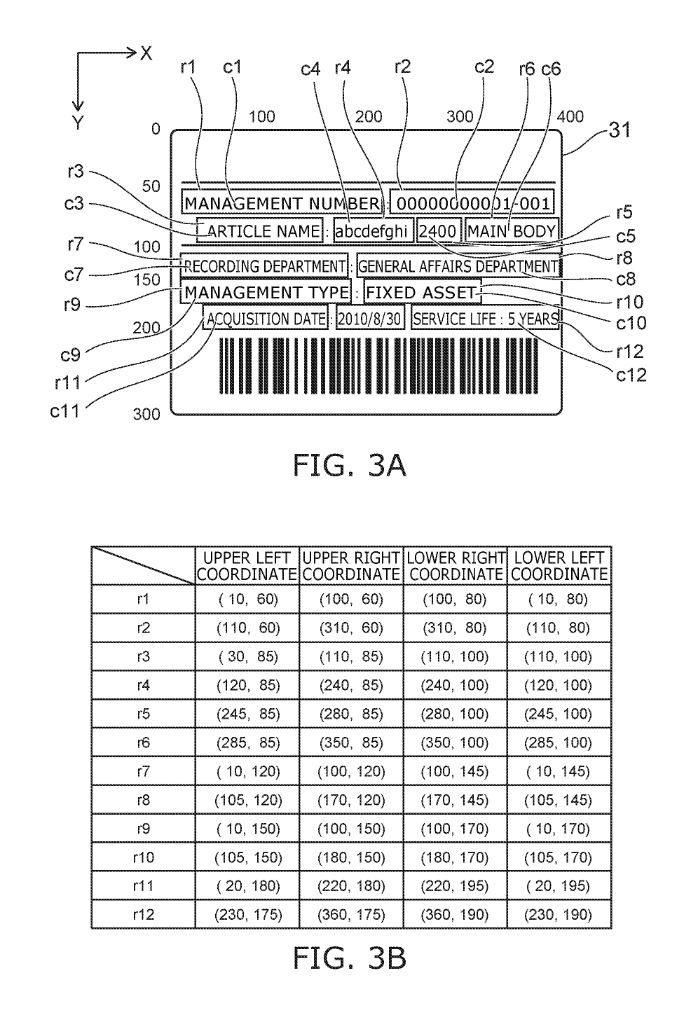

FIG. 3A and FIG. 3B are diagrams illustrating the operation of the detecting unit 21 according to the first embodiment.

FIG. 3A is a schematic view illustrating an image representing a detection result of the detecting unit 21.

FIG. 3B is a diagram illustrating coordinate data representing the detection result of the detecting unit 21.

The detecting unit 21 carries out a detecting operation. The detecting operation includes detecting a plurality of image regions concerning a plurality of character strings from an image. In the embodiment, as shown in FIG. 3A, the detecting unit 21 detects a plurality of image regions r1 to r12 concerning a plurality of character strings c1 to c12 from the image 31. The respective plurality of image regions r1 to r12 are regions set as reading targets of character strings. The respective plurality of image regions r1 to r12 are illustrated as rectangular regions. The plurality of image regions r1 to r12 may be indicated by frame lines or the like surrounding character strings to enable the user to visually recognize the plurality of image regions r1 to r12 on a screen.

As shown in FIG. 3B, upper left coordinates, upper right coordinates, lower right coordinates, and lower right coordinates are detected concerning the respective plurality of image regions r1 to r12. Note that, in the example, a coordinate of the image 31 is represented by an XY coordinate with an upper left corner of the image 31 set as a reference (0, 0). An X coordinate is a coordinate in a lateral direction of the image 31 and is represented, for example, in a range of 0 to 400 from the left to the right. A Y coordinate is a coordinate in a longitudinal direction of the image 31 and is represented, for example, in a range of 0 to 300 from up to down. For example, if the XY coordinate is (10, 60), the X coordinate is 10 and the Y coordinate is 60.

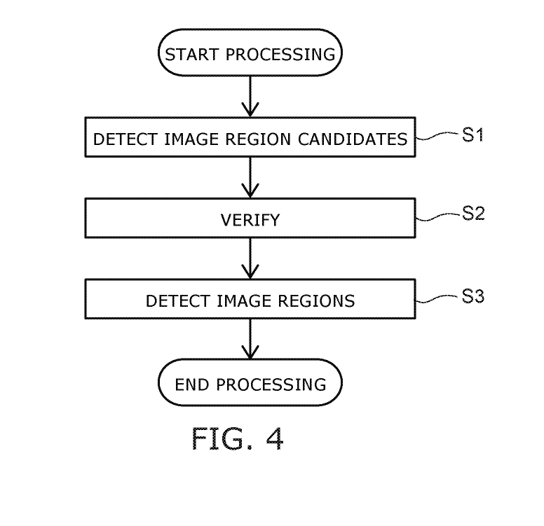

FIG. 4 is a flowchart for describing an operation example of the detecting unit 21 according to the first embodiment.

As shown in FIG. 4, the detecting unit 21 detects a plurality of image region candidates from an image 31 (step S1). The respective pluralities of image region candidates include character string candidates. The detecting unit 21 analyzes the image 31 and detects the sizes and the positions of the respective character candidates configuring the character string candidates. Specifically, for example, there is a method of generating pyramid images having various resolutions with respect to an analysis target image and identifying whether rectangles having a fixed size obtained by segmenting the pyramid images in a licking manner are character candidates. As feature values used for the identification, for example, Joint Haar-like features are used. As a classifier, for example, an Adaptive Boosting algorithm is used. Consequently, it is possible to detect image region candidates at high speed.

The detecting unit 21 verifies whether the image region candidates detected in step S1 include true characters (step S2). For example, there is a method of discarding image region candidates not determined as characters using a classifier such as a Support Vector Machine.

The detecting unit 21 sets, as a character string, a combination of the image region candidates arranged side by side as one character string candidate among the image region candidates not discarded in step S2 and detects an image region including the character string (step S3). Specifically, the detecting unit 21 votes on a (θ-ρ) space representing line parameters using a method such as Hough transform and determines, as a character string, a set of character candidates (a character string candidate) configuring line parameters of voting frequencies.

In this way, the plurality of image regions r1 to r12 concerning the plurality of character strings c1 to c12 are detected from the image 31.

As shown in FIG. 3A, the character strings c4 to c6 correspond to one article name. Therefore, the image regions r4 to r6 including the character strings c4 to c6 are desirably combined into one image region. The plurality of image regions r4 to r6 are combined into one image region by carrying out processing described below.

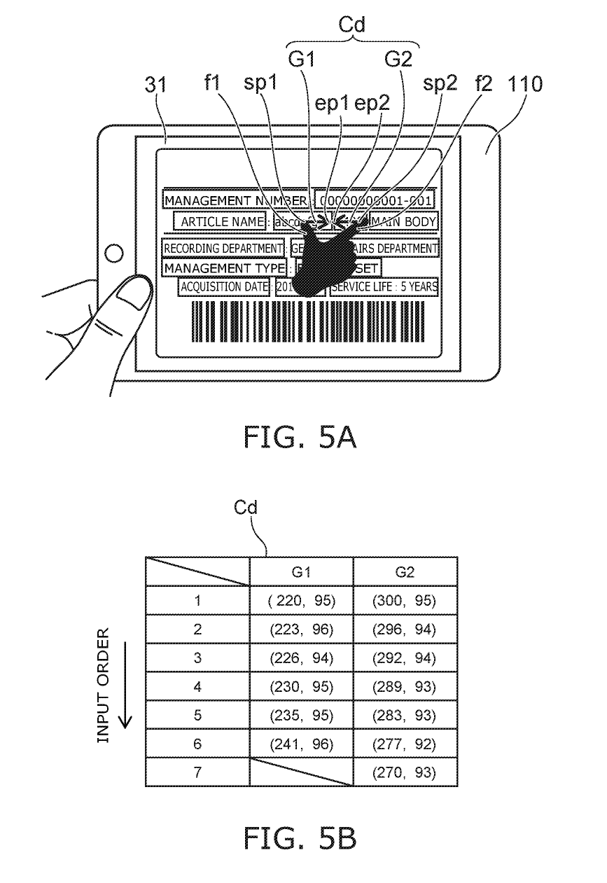

FIG. 5A and FIG. 5B are diagrams illustrating the operation of the receiving unit 22 according to the first embodiment.

FIG. 5A is a schematic view illustrating a coordinate input screen for an input to the receiving unit 22.

FIG. 5B is a diagram illustrating coordinate data representing a result of the input to the receiving unit 22.

In the example, the image 31 is displayed on a screen of the image processing apparatus 110. The image processing apparatus 110 includes, for example, a touch panel that enables touch operation on the screen.

The receiving unit 22 carries out a receiving operation. The receiving operation includes receiving an input of coordinate information concerning coordinates in an image. In the embodiment, as shown in FIG. 5A, the user moves fingers f1 and f2 and performs pinch-in operation on the image 31 displayed on the screen and inputs coordinate information Cd. The pinch-in operation is an operation method for moving the two fingers f1 and f2 in contact with the screen to reduce the distance between the two fingers f1 and f2. The coordinate information Cd includes a first coordinate group G1 and a second coordinate group G2. The first coordinate group G1 includes a plurality of coordinates continuously designated in the image 31. The second coordinate group G2 includes another plurality of coordinates continuously designated in the image 31. The pluralities of coordinates of the first coordinate group G1 correspond to a track of the finger f1. The other pluralities of coordinates of the second coordinate group G2 correspond to a track of the finger f2. The continuously designated plurality of coordinates mean, for example, a set of coordinates acquired in time series. The set of coordinates does not always have to be acquired in time series. The order of the set of coordinates only has to be specified.

As shown in FIG. 5B, the first coordinate group G1 includes, for example, in an input order, a plurality of coordinates (220, 95), (223, 96), (226, 94), (230, 95), (235, 95), and (241, 96). A first start point coordinate sp1 of the first coordinate group G1 is (220, 95). A first end point coordinate ep1 of the first coordinate group G1 is (241, 96). The second coordinate group G2 includes, for example, in an input order, a plurality of coordinates (300, 95), (296, 94), (292, 94), (289, 93), (283, 93), (277, 92), and (270, 93). A second start point coordinate sp2 of the second coordinate group G2 is (300, 95). A second end point coordinate ep2 of the second coordinate group G2 is (270, 93). As shown in FIG. 5A, a direction from the first start point coordinate sp1 to the first end point coordinate ep1 of the first coordinate group G1 is opposite to a direction from the second start point coordinate sp2 to the second end point coordinate ep2 of the second start point coordinate G2.

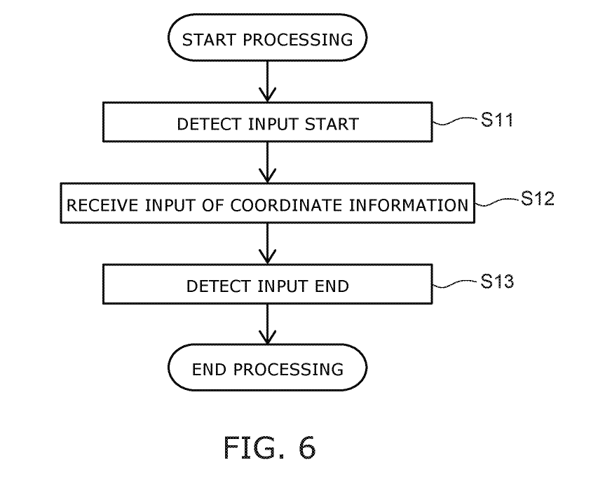

FIG. 6 is a flowchart for describing an operation example of the receiving unit 22 according to the first embodiment.

As shown in FIG. 6, the receiving unit 22 detects a trigger of a reception start of a coordinate input (step S11). For example, as shown in FIG. 5A and FIG. 5B, when the receiving unit 22 is configured to receive an input from the touch panel, the receiving unit 22 detects an event such as touch-down as the trigger. Consequently, the receiving unit 22 starts the reception of the coordinate input.

The receiving unit 22 receives an input of coordinate information according to operation by the user (step S12). Examples of touch operation by the user include pinch-in operation, pinch-out operation, tap operation, and drag operation. In FIG. 5A and FIG. 5B, the pinch-in operation is illustrated. Note that, instead of the touch operation, the user may input coordinate information using a pointing device such as a mouse.

The receiving unit 22 detects a trigger of a reception end of the coordinate input (step S13). For example, the receiving unit 22 detects an event such as touch-up as the trigger. Consequently, the receiving unit 22 ends the reception of the coordinate input.

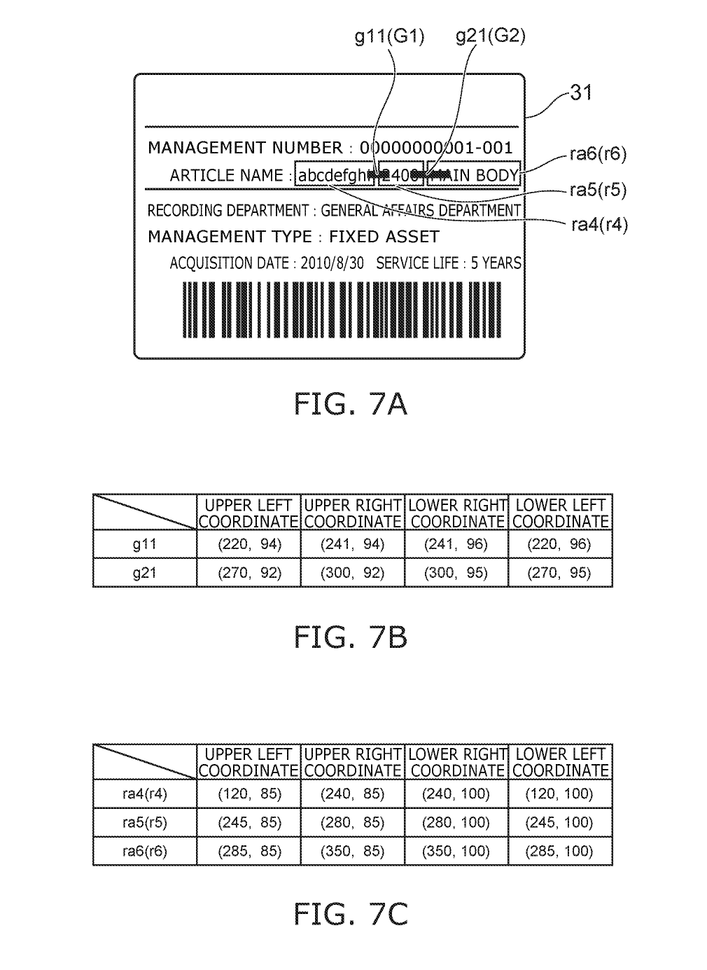

FIG. 7A to FIG. 7C are diagrams illustrating the operation of the extracting unit 23 according to the first embodiment.

FIG. 7A is a schematic view illustrating an image representing coordinate regions respectively corresponding to the first coordinate group G1 and the second coordinate group G2.

FIG. 7B is a diagram illustrating coordinate data representing the coordinate regions respectively corresponding to the first coordinate group G1 and the second coordinate group G2.

FIG. 7C is a diagram illustrating coordinate data representing an extraction result of the extracting unit 23.

The extracting unit 23 carries out an extracting operation. The extracting operation includes extracting, out of a plurality of image regions, designated regions designated by coordinate information. In the embodiment, as shown in FIG. 7A, three designated regions ra4 to ra6 are extracted out of the plurality of image regions r1 to r12 according to a coordinate region g11 and a coordinate region g21. The coordinate region g11 corresponds to the first coordinate group G1. The coordinate region g11 is configured by, for example, a bounding rectangle including coordinates of the first coordinate group G1. The coordinate region g21 corresponds to the second coordinate group G2. The coordinate region g21 is configured by, for example, a bounding rectangle including coordinates of the second coordinate group G2. The extracting unit 23 extracts, as designated regions, for example, image regions overlapping at least parts of the coordinate regions g11 and g21 among the plurality of image regions r1 to r12.

As shown in FIG. 7B, concerning the respective coordinate regions g11 and g21, upper left coordinates, upper right coordinates, lower right coordinates, and lower right coordinates are calculated. Note that the respective coordinates of the coordinate regions g11 and g21 can be calculated from the coordinate information Cd (the first coordinate group G1 and the second coordinate group G2) shown in FIG. 5B.

As shown in FIG. 7C, concerning the respective three designated regions ra4 to ra6, upper left coordinates, upper right coordinates, lower right coordinates, and lower right coordinates are detected. The respective coordinates of the three designated regions ra4 to ra6 are the same as the respective coordinates of the three image regions r4 to r6.

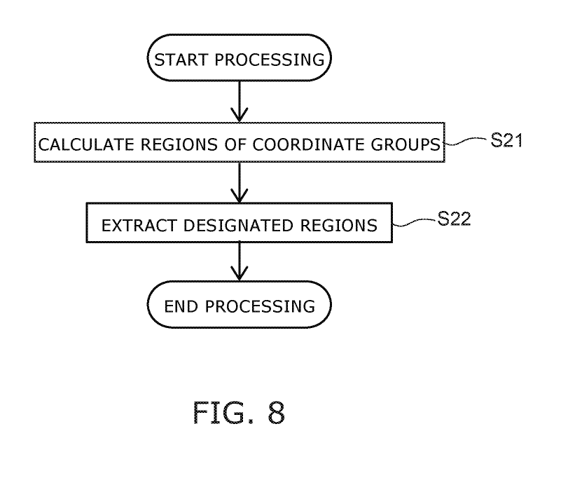

FIG. 8 is a flowchart for describing an operation example of the extracting unit 23 according to the first embodiment.

As shown in FIG. 8, the extracting unit 23 calculates coordinate regions respectively corresponding to the first coordinate group G1 and the second coordinate group G2 (step S21). As shown in FIG. 7A, the coordinate region g11 corresponds to the first coordinate group G1. The coordinate region g11 is configured by, for example, a bounding rectangle including coordinates of the first coordinate group G1. The coordinate region g21 corresponds to the second coordinate group G2. The coordinate region g21 is configured by, for example, a bounding rectangle including coordinates of the second coordinate group G2.

The extracting unit 23 extracts, out of the plurality of image regions r1 to r12, the three designated regions ra4 to ra6 designated by the coordinate regions g11 and g12 (step S22). For example, the extracting unit 23 extracts, as designated regions, image regions overlapping at least parts of the coordinate regions g11 and g21 among the plurality of image regions r1 to r12. As shown in FIG. 7A and FIG. 7C, the three image regions r4 to r6 are extracted as the designated regions ra4 to ra6 out of the plurality of image regions r1 to r12.

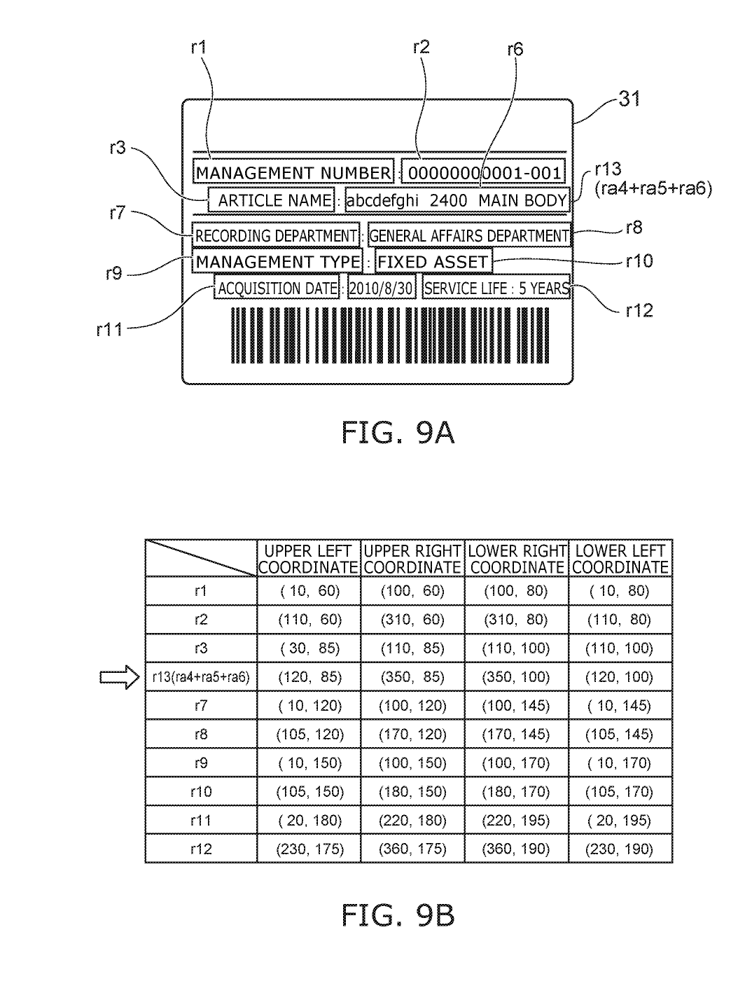

FIG. 9A and FIG. 9B are diagrams illustrating the operation of the generating unit 24 according to the first embodiment.

FIG. 9A is a schematic view illustrating an image representing a generation result of the generating unit 24.

FIG. 9B is a diagram illustrating coordinate data representing the generation result of the generating unit 24.

The generating unit 24 carries out a generating operation. The generating operation includes generating, on the basis of coordinate information, corrected regions obtained by correcting at least one of the number and the size of designated regions. In the embodiment, as shown in FIG. 9A, the generating unit 24 combines the three designated regions ra4 to ra6 on the basis of the first coordinate group G1 and the second coordinate group G2 and generates one corrected region r13. The corrected region r13 is configured as, for example, a bounding rectangle including coordinates of the three designated regions ra4 to ra6.

As shown in FIG. 9B, an upper left coordinate, an upper right coordinate, a lower right coordinate, and a lower left coordinate of the corrected region r13 are detected. The upper left coordinate, the upper right coordinate, the lower right coordinate, and the lower left coordinate are respectively (120, 85), (350, 85), (350, 100), and (120, 100).

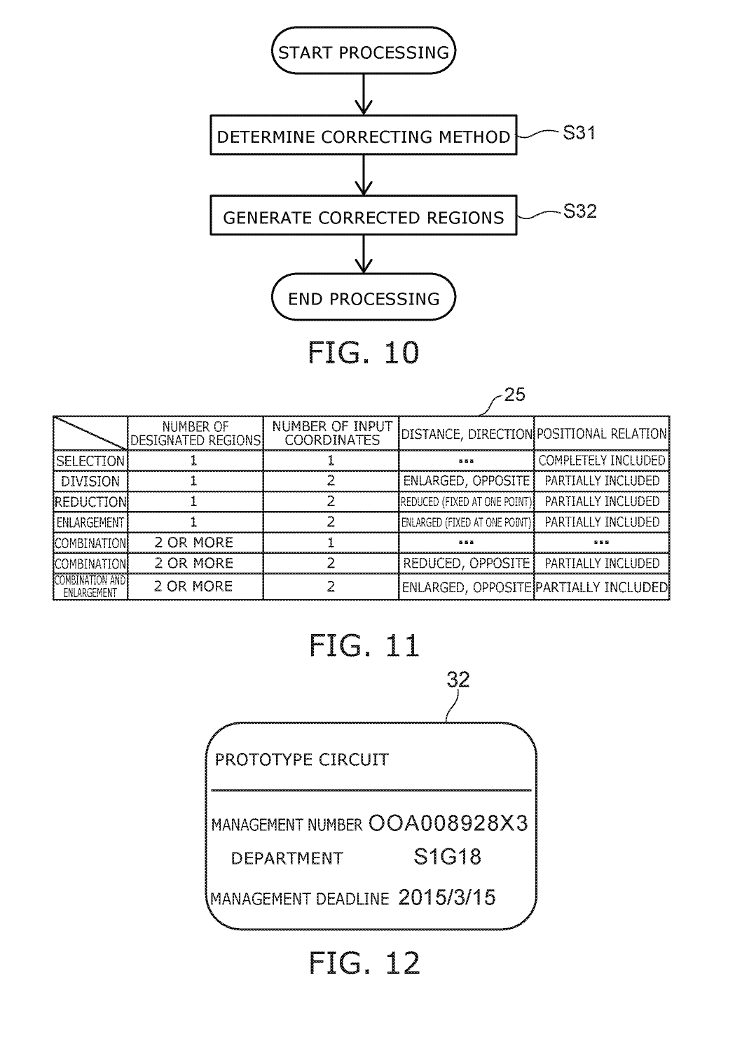

FIG. 10 is a flowchart for describing an operation example of the generating unit 24 according to the first embodiment.

FIG. 11 is a diagram illustrating the classification table 25.

As shown in FIG. 10, the generating unit 24 determines a correcting method using the classification table 25 (step S31). As described above, the first start point coordinate sp1 of the first coordinate group G1 is (220, 95). The first end point coordinate ep1 of the first coordinate group G1 is (241, 96). The second start point coordinate sp2 of the second coordinate group G2 is (300, 95). The second end point coordinate ep2 of the second coordinate group G2 is (270, 93). The generating unit 24 calculates an inter-start point coordinate distance and an inter-end point coordinate distance from the start point coordinates and the end point coordinates. The generating unit 24 calculates the distances using only X coordinates. A method of calculating the distances is not limited to this.

The inter-start point coordinate distance between the first start point coordinate sp1 (220, 95) of the first coordinate group G1 and the second start point coordinate sp2 (300, 95) of the second coordinate group G2 is calculated as 300−220=80. The inter-end point coordinate distance between the first end point coordinate ep1 (241, 96) of the first coordinate group G1 and the second end point coordinate ep2 (270, 93) of the second coordinate group G2 is calculated as 270−241=29. Therefore, there is a relation of the inter-start point coordinate distance>the inter-end point coordinate distance. Further, as shown in FIG. 5A, a direction from the first start point coordinate sp1 to the first end point coordinate ep1 of the first coordinate group G1 is opposite to a direction from the second start point coordinate sp2 to the second end point coordinate ep2 of the second coordinate group G2. That is, it is recognized that the operation by the user is the pinch-in operation.

The generating unit 24 determines a correcting method referring to the classification table 25 shown in FIG. 11. In the classification table 25, the number of designated regions means the number of designated regions extracted by the extracting unit 23. The number of input coordinates means the number of coordinates and coordinate groups configuring the coordinate information Cd. One coordinate group in, for example, pinch operation for moving two fingers is counted as one. One coordinate in, for example, pinch operation or tap operation fixed at one point for fixing one finger and moving another finger is also counted as one. A distance means a size relation between the inter-start point coordinate distance and the inter-end point coordinate distance. If the inter-start point coordinate distance>the inter-end point coordinate distance, the distance is “decreased”. If the inter-start point coordinate distance<the inter-end point coordinate distance, the distance is “increased”. A direction means a relation between the direction from the first start point coordinate sp1 to the first end point coordinate ep1 of the first coordinate group G1 and the direction from the second start point coordinate sp2 to the second end point coordinate ep2 of the second coordinate group G2. If these two directions are opposite to each other, the direction is “opposite”. A positional relation means a positional relation between a designated region and a coordinate group. If at least a part of the coordinate group is included in the designated region, the positional relation is “partially included”. If the coordinate is completely included in the designated region, the positional relation is “completely included”.

Examples of a correcting method for the designated region include selection, division, reduction, enlargement, combination, and combination and enlargement. In the selection, one designated region is selected. In the division, one designated region is divided into a plurality of designated regions. In the reduction, one designated region is reduced. In the enlargement, one designated region is enlarged. In the combination, a plurality of designated regions are combined into one designated region. In the combination and enlargement, a plurality of designated regions are combined into one designated region and the one designated region is enlarged. In the embodiment, the number of designated regions is “3”, the number of input coordinates is “2”, the distance is “reduced”, the direction is “opposite”, and the positional relation is “partially included”. Consequently, when the classification table 25 is referred to, the correcting method is determined as the combination.

As shown in FIG. 9A, the generating unit 24 combines the three designated regions ra4 to ra6 on the basis of the correcting method determined in step S31 and generates one corrected region r13 (step S32).

For example, there is a reference example in which, when characters corresponding to input items are read from an image obtained by photographing a label for management stuck to an article, a user traces a reading region with a finger or the like of the user to designate the reading region. In the reference example, complicated touch operation by the finger of the user is necessary to include a plurality of character strings in one reading region. Specifically, the user sets a start point near the first character of the first character string, traces characters to the last character of the last character string, and sets an end point near the last character. In the reference example, in the case of a character string in which a plurality of words are not linearly arranged, a character string in which a plurality of words are complicatedly arranged, and the like, it is difficult to accurately trace all character strings and designate a reading region.

On the other hand, the image processing apparatus 110 according to the embodiment detects a plurality of image regions serving as reading regions from an image. The image processing apparatus 110 corrects, according to the operation (pinch-in, etc.) by the user, image regions where characters are excessive or insufficient and desired character strings are not formed among the plurality of image regions and generates image regions composed of the desired character strings. Consequently, even in the case of a character string in which a plurality of words are not linearly arranged, a character string in which a plurality of words are complicatedly arranged, and the like, it is possible to efficiently read characters with simple operation.

### Second Embodiment

FIG. 12 is a schematic view illustrating an image according to a second embodiment.

The acquiring unit 10 acquires an image 32. The image 32 includes a plurality of character strings. Among the plurality of character strings, a management number, a department, and a management deadline are respectively input items.

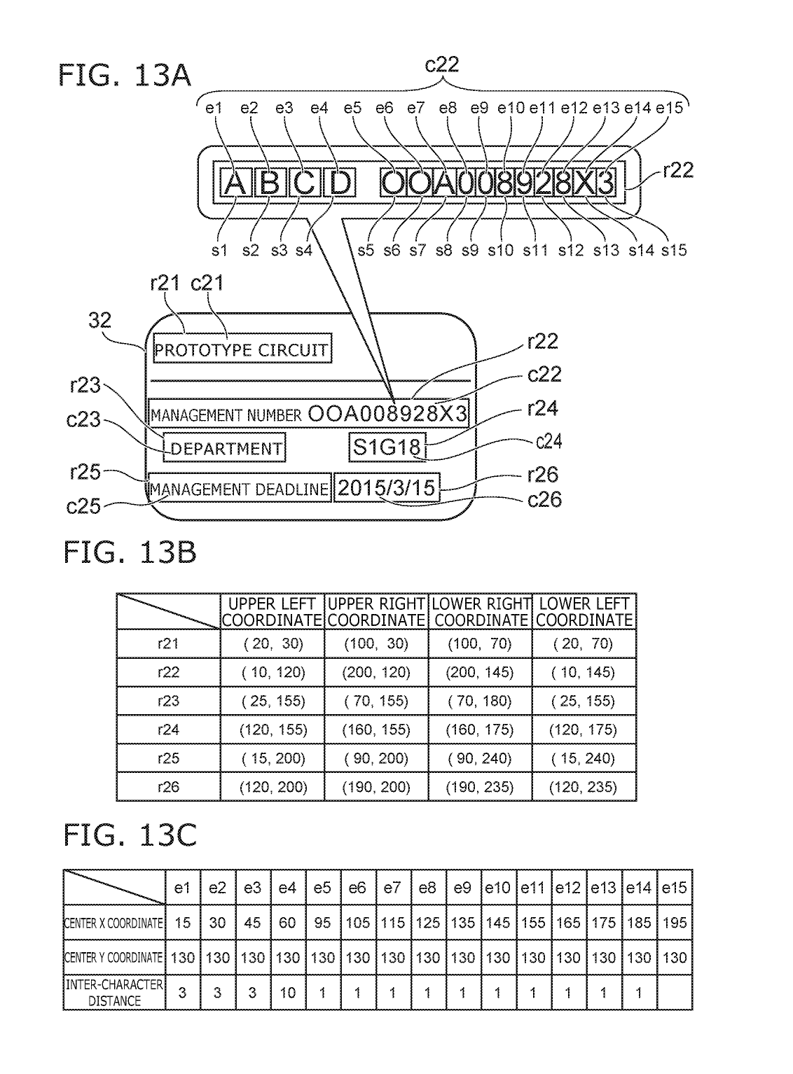

FIG. 13A to FIG. 13C are diagrams illustrating the operation of the detecting unit 21 according to the second embodiment.

FIG. 13A is a schematic view illustrating an image representing a detection result of the detecting unit 21.

FIG. 13B is a diagram illustrating coordinate data representing the detection result of the detecting unit 21.

FIG. 13C is a diagram illustrating attribute data detected by the detecting unit 21.

The detecting unit 21 carries out a detecting operation. The detecting operation includes detecting a plurality of image regions concerning a plurality of character strings from an image, detecting an attribute for each of characters included in character strings included in the respective plurality of image regions, and setting rectangular regions surrounding respective pluralities of characters of the character strings. In the embodiment, as shown in FIG. 13A, the detecting unit 21 detects a plurality of image regions r21 to r26 concerning a plurality of character strings c21 to c26 from the image 32. The respective plurality of image regions r21 to r26 are regions set as reading targets of character strings. The respective plurality of image regions r21 to r26 are illustrated as rectangular regions. The plurality of image regions r21 to r26 may be indicated by frame lines or the like surrounding character strings to enable a user to visually recognize the plurality of image regions r21 to r26 on a screen.

For example, the image region r22 includes the character string c22. The character string c22 includes a plurality of characters e1 to e15. The respective plurality of characters e1 to e15 are surrounded by a respective plurality of rectangular regions s1 to s15. The same applies to the character strings c21 and c23 to c26 other than the character string c22.

As shown in FIG. 13B, concerning the respective plurality of image regions r21 to r26, upper left coordinates, upper right coordinates, lower right coordinates, and lower right coordinates are detected. Note that, in the example, a coordinate of the image 32 is represented by an XY coordinate with an upper left corner of the image 32 set as a reference (0, 0). An X coordinate is a coordinate in a lateral direction of the image 32 and is represented, for example, in a range of 0 to 400 from the left to the right. A Y coordinate is a coordinate in a longitudinal direction of the image 32 and is represented, for example, in a range of 0 to 300 from up to down.

The detecting unit 21 sets rectangular regions surrounding respective pluralities of characters configuring the character strings c21 to c26. The detecting unit 21 detects an attribute for each of the characters of the character strings c21 to c26. For example, a result obtained by detecting attributes of the characters e1 to e15 of the character string c22 is shown in FIG. 13C. The attribute includes, for example, an inter-character distance. Center of gravity points of the respective rectangular regions S1 to s15 are calculated. A distance between the center of gravity points of adjacent two characters only has to be set as the inter-character distance. The inter-character distance may be the length of a portion outside rectangular regions of characters in a line segment connecting the center of gravity points of the adjacent two characters. In the example, an inter-character distance between the character e4 and the character e5 is the largest.

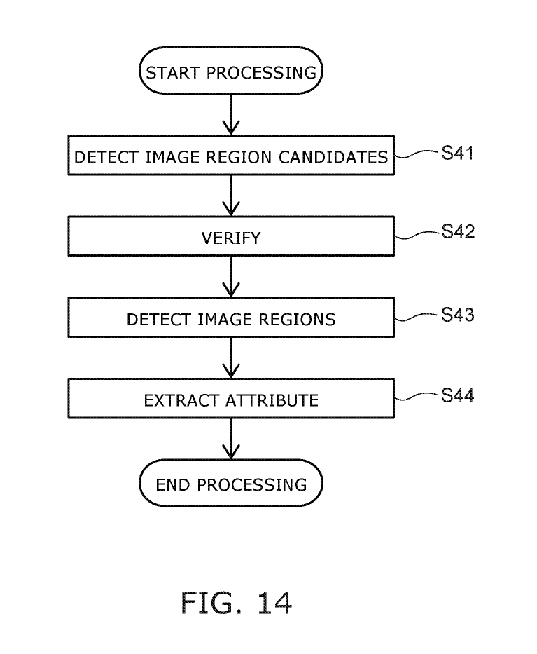

FIG. 14 is a flowchart for describing an operation example of the detecting unit 21 according to the second embodiment.

As shown in FIG. 14, the detecting unit 21 detects a plurality of image region candidates from the image 32 (step S41). The respective plurality of image region candidates include character string candidates. The detecting unit 21 analyzes the image 32 and detects the sizes and the positions of respective character candidates configuring the character string candidates. Specifically, for example, there is a method of generating pyramid images having various resolutions with respect to an analysis target image and identifying whether rectangles having a fixed size obtained by segmenting the pyramid images in a licking manner are character candidates. As feature values used for the identification, for example, Joint Haar-like features are used. As a discriminator, for example, an Adaptive Boosting algorithm is used. Consequently, it is possible to detect image region candidates at high speed.

The detecting unit 21 verifies whether the image region candidates detected in step S41 include true characters (step S42). For example, there is a method of discarding image region candidates not determined as characters using a classifier such as a Support Vector Machine.

The detecting unit 21 sets, as a character string, a combination of the image region candidates arranged side by side as one character string candidate among the image region candidates not discarded in step S42 and detects an image region including the character string (step S43). Specifically, the detecting unit 21 votes on a (θ-ρ) space representing line parameters using a method such as Hough transform and determines, as a character string, a set of character candidates (a character string candidate) configuring line parameters of voting frequencies.

In this way, the plurality of image regions r21 to r26 concerning the plurality of character strings c21 to c26 are detected from the image 32.

The detecting unit 21 detects an attribute for each of the characters of the character strings c21 to c26 included in the respective plurality of image regions r21 to r26 (step S44). For example, as shown in FIG. 13C, the detecting unit 21 detects attributes of the characters e1 to e15 of the character string c22. The attribute includes, for example, an inter-character distance. Center of gravity points of the respective rectangular regions s1 to s15 are calculated. A distance between the center of gravity points of adjacent two characters only has to be set as the inter-character distance. The inter-character distance may be the length of a portion outside rectangular regions of characters in a line segment connecting the center of gravity points of the adjacent two characters. In the example, an inter-character distance between the character e4 and the character e5 is the largest.

As shown in FIG. 13A, the character string c22 includes an input item (a management number: character string “ABCD”) and a character string (OOA008928X3) corresponding to the input item. Therefore, the image region r22 including the character string c22 is desirably divided into two image regions. One image region r22 is divided into two image regions by carrying out processing described below.

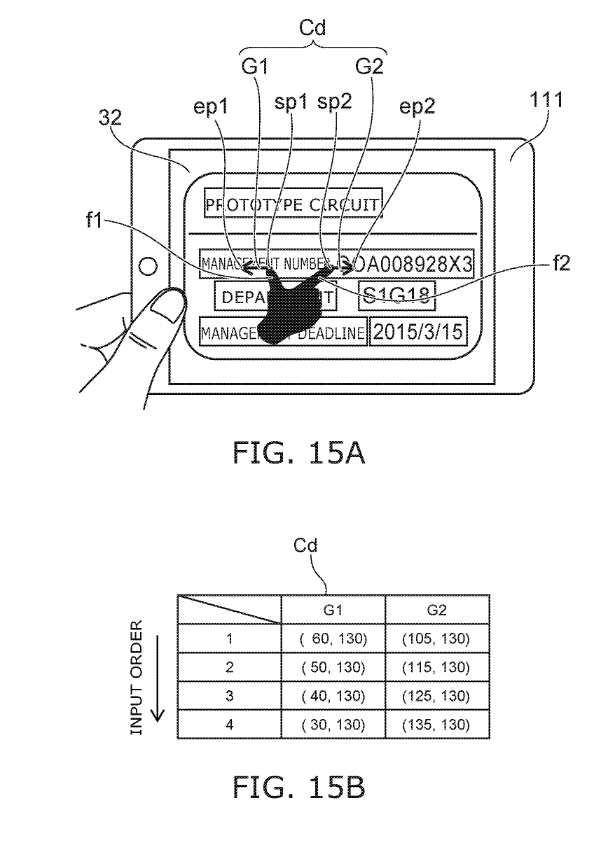

FIG. 15A and FIG. 15B are diagrams illustrating the operation of the receiving unit 22 according to the second embodiment.

FIG. 15A is a schematic view illustrating a coordinate input screen for an input to the receiving unit 22.

FIG. 15B is a diagram illustrating coordinate data representing a result of the input to the receiving unit 22.

In the example, the image 32 is displayed on a screen of an image processing apparatus 111. The image processing apparatus 111 includes, for example, a touch panel that enables touch operation on the screen.

The receiving unit 22 receives an input of coordinate information concerning coordinates in an image. In the embodiment, as shown in FIG. 15A, the user moves the fingers f1 and f2 to perform pinch-out operation on the image 32 displayed on the screen and inputs the coordinate information Cd. The pinch-out operation is an operation method for moving the two fingers f1 and f2 in contact with the screen to increase the distance between the two fingers f1 and f2. The coordinate information Cd includes the first coordinate group G1 and the second coordinate group G2. The first coordinate group G1 includes a plurality of coordinates continuously designated in the image 32. The second coordinate group G2 includes another plurality of coordinates continuously designated in the image 32. The plurality of coordinates of the first coordinate group G1 correspond to a track of the finger f1. The other plurality of coordinates of the second coordinate group G2 correspond to a track of the finger f2. The continuously designated plurality of coordinates mean, for example, a set of coordinates acquired in time series. The set of coordinates does not always have to be acquired in time series. The order of the set of coordinates only has to be specified.

As shown in FIG. 15B, the first coordinate group G1 includes, for example, in an input order, a plurality of coordinates (60, 130), (50, 130), (40, 130), and (30, 130). The first start point coordinate sp1 of the first coordinate group G1 is (60, 130). The first end point coordinate ep1 of the first coordinate group G1 is (30, 130). The second coordinate group G2 includes, for example, in an input order, a plurality of coordinates (105, 130), (115, 130), (125, 130), and (135, 130). The second start point coordinate sp2 of the second coordinate group G2 is (105, 130). The second end point coordinate ep2 of the second coordinate group G2 is (135, 130). As shown in FIG. 15A, a direction from the first start point coordinate sp1 to the first end point coordinate ep1 of the first coordinate group G1 is opposite to a direction from the second start point coordinate sp2 to the second end point coordinate ep2 of the second start point coordinate G2.

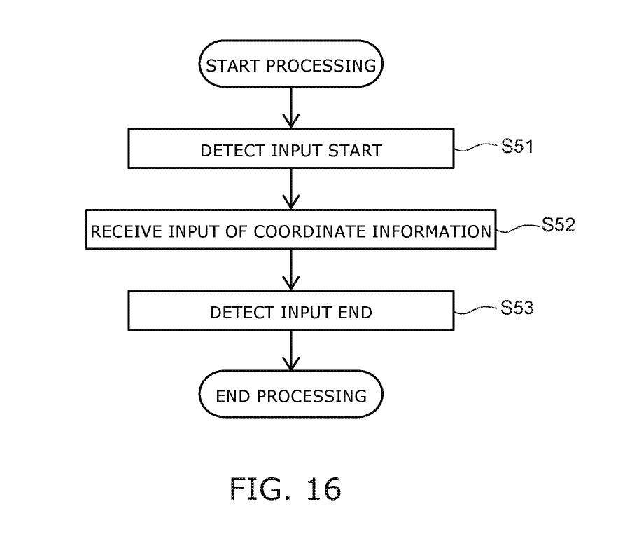

FIG. 16 is a flowchart for describing an operation example of the receiving unit 22 according to the second embodiment.

As shown in FIG. 16, the receiving unit 22 detects a trigger of a reception start of a coordinate input (step S51). For example, as shown in FIG. 15A and FIG. 15B, when the receiving unit 22 is configured to receive an input from the touch panel, the receiving unit 22 detects an event such as touch-down as the trigger. Consequently, the receiving unit 22 starts the reception of the coordinate input.

The receiving unit 22 receives an input of coordinate information according to operation by the user (step S52). Examples of touch operation by the user include pinch-in operation, pinch-out operation, tap operation, and drag operation. In FIG. 15A and FIG. 15B, the pinch-out operation is illustrated. Note that, instead of the touch operation, the user may input coordinate information using a pointing device such as a mouse.

The receiving unit 22 detects a trigger of a reception end of the coordinate input (step S53). For example, the receiving unit 22 detects an event such as touch-up as the trigger. Consequently, the receiving unit 22 ends the reception of the coordinate input.

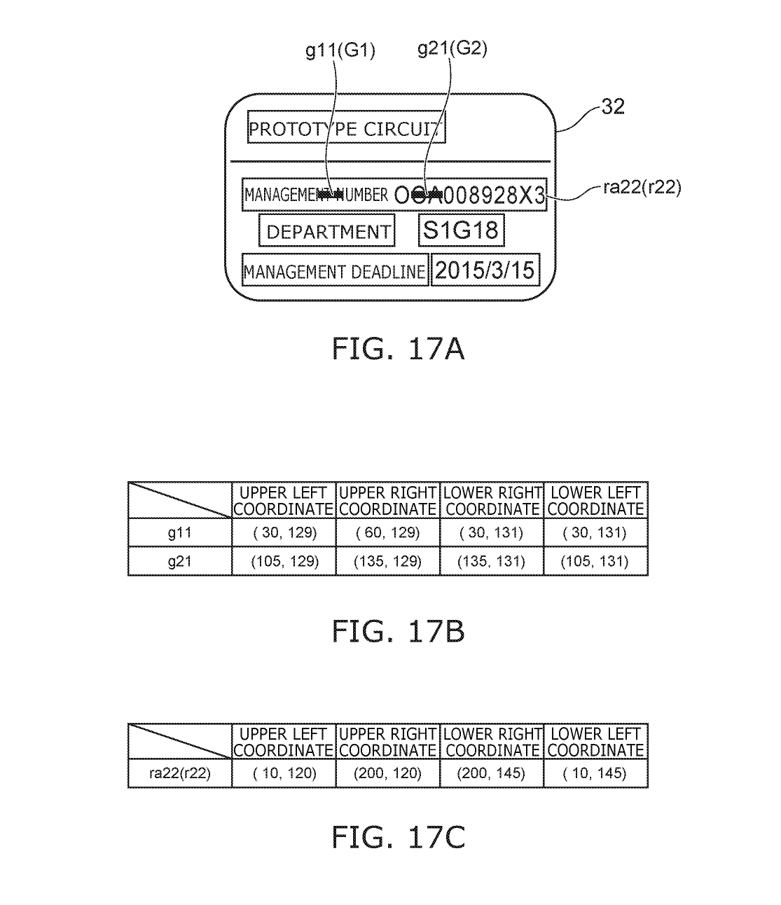

FIG. 17A to FIG. 17C are diagrams illustrating the operation of the extracting unit 23 according to the second embodiment.

FIG. 17A is a schematic view illustrating an image representing coordinate regions respectively corresponding to the first coordinate group G1 and the second coordinate group G2.

FIG. 17B is a diagram illustrating coordinate data representing the coordinate regions respectively corresponding to the first coordinate group G1 and the second coordinate group G2.

FIG. 17C is a diagram illustrating coordinate data representing an extraction result of the extracting unit 23.

The extracting unit 23 extracts, out of a plurality of image regions, designated regions designated by coordinate information. In the embodiment, as shown in FIG. 17A, one designated region ra22 is extracted out of the plurality of image regions r21 to r26 according to the coordinate region g11 and the coordinate region g21. The coordinate region g11 corresponds to the first coordinate group G1. The coordinate region g11 is configured by, for example, a bounding rectangle including coordinates of the first coordinate group G1. The coordinate region g21 corresponds to the second coordinate group G2. The coordinate region g21 is configured by, for example, a bounding rectangle including coordinates of the second coordinate group G2. The extracting unit 23 extracts, as designated regions, for example, image regions overlapping the coordinate regions g11 and g21 among the plurality of image regions r21 to r26.

As shown in FIG. 17B, concerning the respective coordinate regions g11 and g21, upper left coordinates, upper right coordinates, lower right coordinates, and lower right coordinates are calculated. Note that respective coordinates of the coordinate regions g11 and g21 can be calculated from the coordinate information Cd (the first coordinate group G1 and the second coordinate group G2) shown in FIG. 15B.

As shown in FIG. 17C, concerning the one designated region ra22, an upper left coordinate, an upper right coordinate, a lower right coordinate, and a lower right coordinate are detected. The coordinates of the one designated region ra22 are the same as the coordinates of the one image region r22.

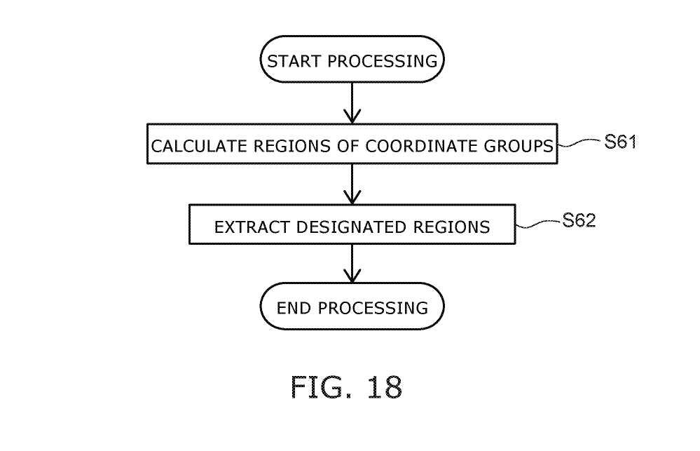

FIG. 18 is a flowchart for describing an operation example of the extracting unit 23 according to the second embodiment.

As shown in FIG. 18, the extracting unit 23 calculates coordinate regions respectively corresponding to the first coordinate group G1 and the second coordinate group G2 (step S61). As shown in FIG. 17A, the coordinate region g11 corresponds to the first coordinate group G1. The coordinate region g11 is configured by, for example, a bounding rectangle including coordinates of the first coordinate group G1. The coordinate region g21 corresponds to the second coordinate group G2. The coordinate region g21 is configured by, for example, a bounding rectangle including coordinates of the second coordinate group G2.

The extracting unit 23 extracts, out of the plurality of image regions r21 to r26, one designated region ra22 designated by the coordinate regions g11 and g21 (step S62). For example, the extracting unit 23 extracts, as designated regions, image regions overlapping the coordinate regions g11 and g21 among the plurality of image regions r21 to r26. As shown in FIG. 17A and FIG. 17C, the one image region r22 is extracted as the designated region ra22 out of the plurality of image regions r21 to r26.

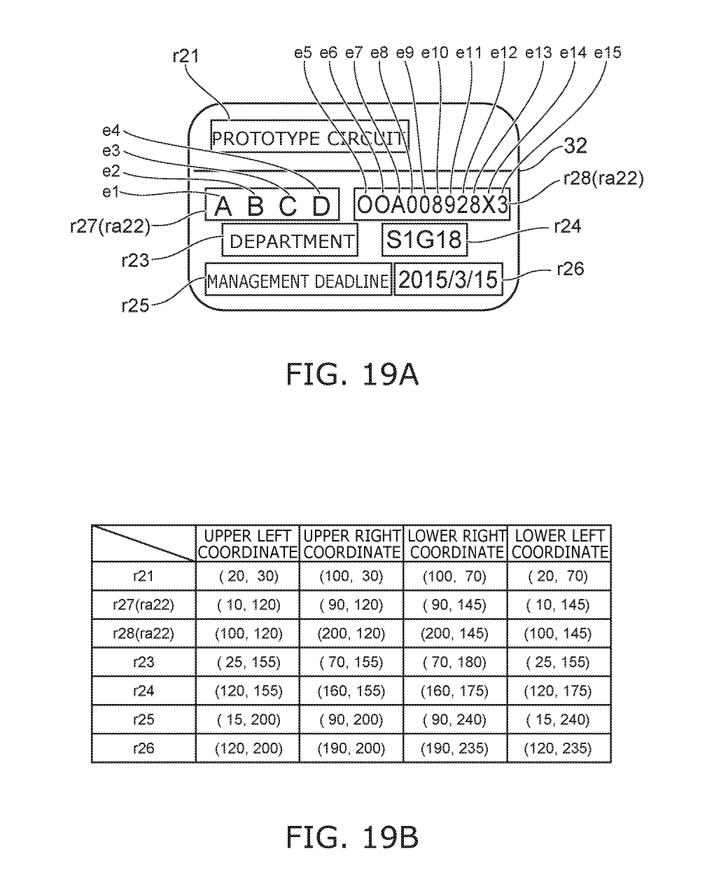

FIG. 19A and FIG. 19B are diagrams illustrating the operation of the generating unit 24 according to the second embodiment.

FIG. 19A is a schematic view illustrating an image representing a generation result of the generating unit 24.

FIG. 19B is a diagram illustrating coordinate data representing the generation result of the generating unit 24.

The generating unit 24 generates, on the basis of coordinate information, corrected regions obtained by correcting at least one of the number and the size of designated regions. In the embodiment, as shown in FIG. 19A, the generating unit 24 divides the one designated region ra22 on the basis of the first coordinate group G1 and the second coordinate group G2 and generates a plurality of corrected regions r27 and r28. The designated region ra22 is divided on the basis of attributes such as an inter-character distance. The corrected region r27 is configured as, for example, a bounding rectangle including coordinates of one of two divided regions of the one designated region ra22. The corrected region r28 is configured as, for example, a bounding rectangle including coordinates of the other of the two divided regions of the one designated region ra22.

As shown in FIG. 19B, upper left coordinates, upper right coordinates, lower right coordinates, and lower left coordinates of the respective corrected regions r27 and r28 are detected. The upper left coordinate, the upper right coordinate, the lower right coordinate, and the lower left coordinate of the corrected region r27 are respectively (10, 120), (90, 120), (90, 145), and (10, 145). The upper left coordinate, the upper right coordinate, the lower right coordinate, and the lower left coordinate of the corrected region r28 are respectively (100, 120), (200, 120), (200, 145), and (100, 145).

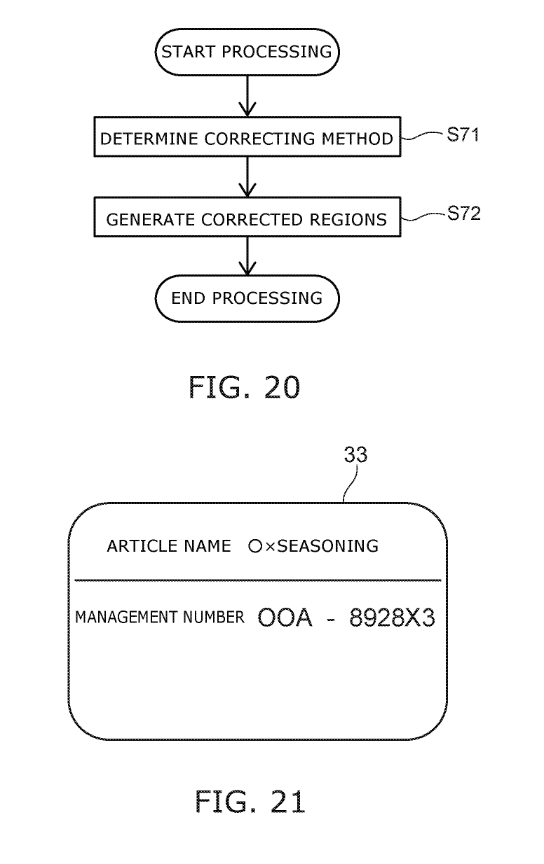

FIG. 20 is a flowchart for describing an operation example of the generating unit 24 according to the second embodiment.

As shown in FIG. 20, the generating unit 24 determines a correcting method using the classification table 25 (FIG. 11) (step S71). As described above, the first start point coordinate sp1 of the first coordinate group G1 is (60, 130). The first end point coordinate ep1 of the first coordinate group G1 is (30, 130). The second start point coordinate sp2 of the second coordinate group G2 is (105, 130). The second end point coordinate ep2 of the second coordinate group G2 is (135, 130). The generating unit 24 calculates an inter-start point coordinate distance and an inter-end point coordinate distance from the start point coordinates and the end point coordinates. The generating unit 24 calculates the distances using only X coordinates.

The inter-start point coordinate distance between the first start point coordinate sp1 (60, 130) of the first coordinate group G1 and the second start point coordinate sp2 (105, 130) of the second coordinate group G2 is calculated as 105−60=45. The inter-end point coordinate distance between the first end point coordinate ep1 (30, 130) of the first coordinate group G1 and the second end point coordinate ep2 (135, 130) of the second coordinate group G2 is calculated as 135−30=105. Therefore, there is a relation of the inter-start point coordinate distance<the inter-end point coordinate distance. Further, as shown in FIG. 15A, a direction from the first start point coordinate sp1 to the first end point coordinate ep1 of the first coordinate group G1 is opposite to a direction from the second start point coordinate sp2 to the second end point coordinate ep2 of the second coordinate group G2. That is, it is recognized that the operation by the user is the pinch-out operation.

The generating unit 24 determines a correcting method referring to the classification table 25 shown in FIG. 11. In the embodiment, the number of designated regions is “1”, the number of input coordinates is “2”, the distance is “increased”, the direction is “opposite”, and the positional relation is “partially included”. Consequently, when the classification table 25 is referred to, the correcting method is determined as the division.

As shown in FIG. 19A, the generating unit 24 divides the one designated region ra22 on the basis of the correcting method determined in step S71 and generates two corrected regions r27 and r28 (step S72). In the embodiment, the designated region ra22 is divided on the basis of an attribute. The attribute is, for example, an inter-character distance. The designated region ra22 is divided between two characters having a largest inter-character distance. According to the example shown in FIG. 13C, an inter-character distance between the character e4 and the character e5 is the largest. In this case, the designated region ra22 is divided between the character e4 and the character e.

The attribute is not limited to the inter-character distance. The attribute may include at least one of, for example, a character color, a character size, and an aspect ratio. In this case, the designated region ra22 is divided between two characters different in at least one of the character color, the character size, and the aspect ratio. For example, in FIG. 19A, if a character color of the characters e1 to e4 and a character color of the characters e5 to e15 are different, the designated region ra22 is divided between the character e4 and the character e5. The character size and the aspect ratio can be calculated on the basis of the rectangular regions s1 to s15 shown in FIG. 13A. The same division processing can be performed using the character size and the aspect ratio.

The image processing apparatus 111 according to the embodiment detects a plurality of image regions serving as reading regions from an image. The image processing apparatus 111 corrects, according to the operation (pinch-out, etc.) by the user and the attributes, image regions where characters are excessive or insufficient and desired character strings are not formed among the plurality of image regions and generates image regions composed of the desired character strings. Consequently, even in the case of a character string in which a plurality of words are not linearly arranged, a character string in which a plurality of words are complicatedly arranged, and the like, it is possible to efficiently read characters with simple operation.

### Third Embodiment

FIG. 21 is a schematic view illustrating an image according to a third embodiment.

The acquiring unit 10 acquires an image 33. The image 33 includes a plurality of character strings. Among the plurality of character strings, an article name and a management number (character string “ABCD”) respectively correspond to input items.

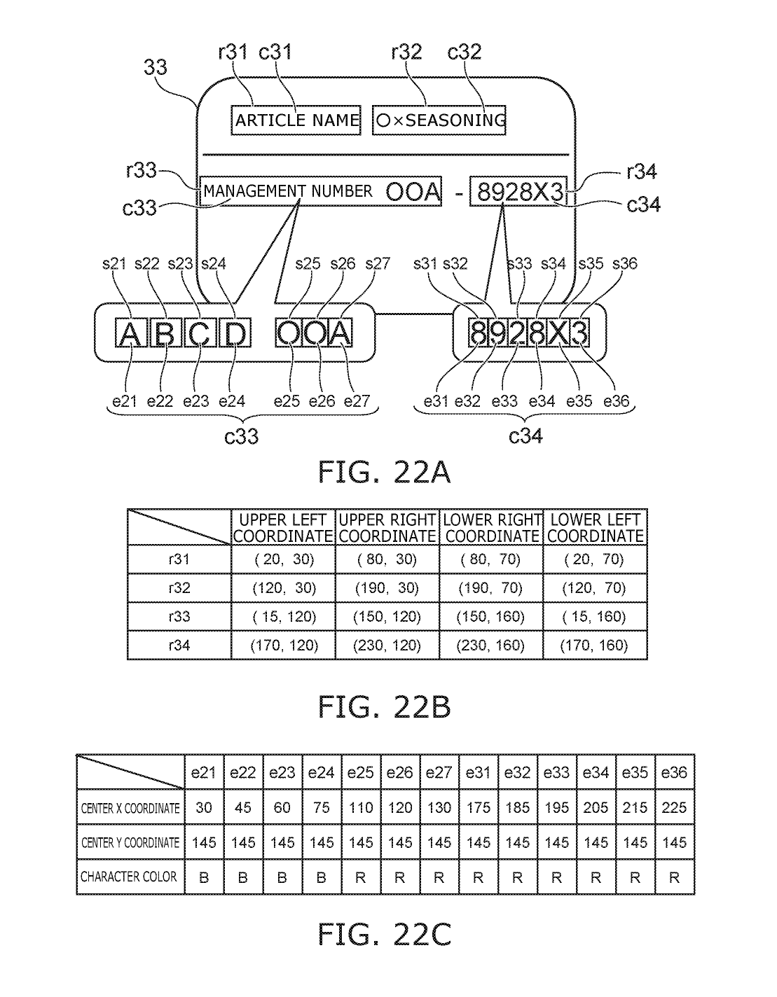

FIG. 22A to FIG. 22C are diagrams illustrating the operation of the detecting unit 21 according to a third embodiment.

FIG. 22A is a schematic view illustrating an image representing a detection result of the detecting unit 21.

FIG. 22B is a diagram illustrating coordinate data representing the detection result of the detecting unit 21.

FIG. 22C is a diagram illustrating attribute data detected by the detecting unit 21.

The detecting unit 21 carries out a detecting operation. The detecting operation includes detecting a plurality of image regions concerning a plurality of character strings from an image, detecting an attribute for each of characters included in character strings included in the respective plurality of image regions, and setting rectangular regions surrounding respective pluralities of characters of the character strings. In the embodiment, as shown in FIG. 22A, the detecting unit 21 detects a plurality of image regions r31 to r34 concerning a plurality of character strings c31 to c34 from the image 33. The respective plurality of image regions r31 to r34 are regions set as reading targets of character strings. The respective plurality of image regions r31 to r34 are illustrated as rectangular regions. The plurality of image regions r31 to r34 may be indicated by frame lines or the like surrounding character strings to enable a user to visually recognize the plurality of image regions r31 to r34 on a screen.

For example, the image region r33 includes the character string c33. The character string c33 includes a plurality of characters e21 to e27. The respective plurality of characters e21 to e27 are surrounded by a respective plurality of rectangular regions s21 to s27. The image region r34 includes the character string c34. The character string c34 includes a plurality of characters e31 to e36. The respective plurality of characters e31 to e36 are surrounded by a respective plurality of rectangular regions s31 to s36. The same applies to the character strings c31 and c32 other than the character strings c33 and c34.

As shown in FIG. 22B, concerning the respective plurality of image regions r31 to r34, upper left coordinates, upper right coordinates, lower right coordinates, and lower right coordinates are detected. Note that, in the example, a coordinate of the image 33 is represented by an XY coordinate with an upper left corner of the image 33 set as a reference (0, 0). An X coordinate is a coordinate in a lateral direction of the image 33 and is represented, for example, in a range of 0 to 400 from the left to the right. A Y coordinate is a coordinate in a longitudinal direction of the image 33 and is represented, for example, in a range of 0 to 300 from up to down.

The detecting unit 21 detects an attribute for each of the characters of the character strings c31 to c34 included in the respective plurality of image regions r31 to r34. For example, a result obtained by detecting attributes of the respective characters e21 to e27 of the character string c33 and attributes of the respective characters e31 to e36 of the character string c34 is shown in FIG. 22C. The attribute includes, for example, at least one of a character color, a character size, and an aspect ratio. In the example, the attribute is the character color. Note that the character size and the aspect ratio can be calculated on the basis of, for example, rectangular regions s21 to s27 and s31 to s36 shown in FIG. 22A.

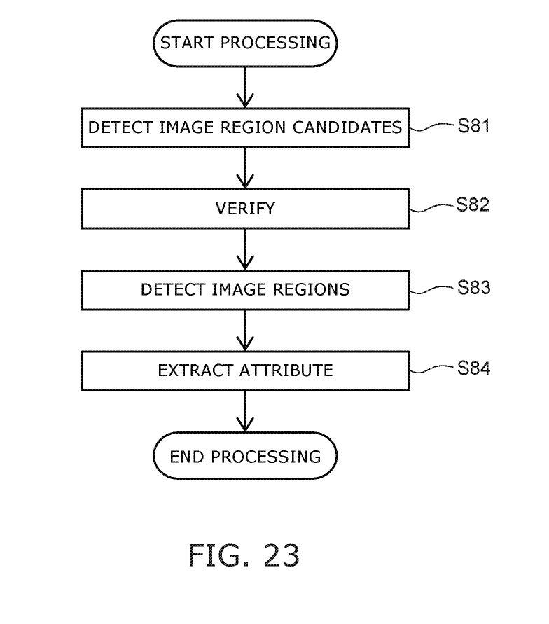

FIG. 23 is a flowchart for describing an operation example of the detecting unit 21 according to the third embodiment.

As shown in FIG. 23, the detecting unit 21 detects a plurality of image region candidates from the image 33 (step S81). The respective plurality of image region candidates include character string candidates. The detecting unit 21 analyzes the image 33 and detects the sizes and the positions of respective character candidates configuring the character string candidates. Specifically, for example, there is a method of generating pyramid images having various resolutions with respect to an analysis target image and identifying whether rectangles having a fixed size obtained by segmenting the pyramid images in a licking manner are character candidates. As feature values used for the identification, for example, Joint Haar-like features are used. As classifier, for example, an Adaptive Boosting algorithm is used. Consequently, it is possible to detect image region candidates at high speed.

The detecting unit 21 verifies whether the image region candidates detected in step S81 include true characters (step S82). For example, there is a method of discarding image region candidates not determined as characters using a classifier such as a Support Vector Machine.

The detecting unit 21 sets, as a character string, a combination of the image region candidates arranged side by side as one character string candidate among the image region candidates not discarded in step S82 and detects an image region including the character string (step S83). Specifically, the detecting unit 21 votes on a (θ-ρ) space representing line parameters using a method such as Hough transform and determines, as a character string, a set of character candidates (a character string candidate) configuring line parameters of voting frequencies.

In this way, the plurality of image regions r31 to r34 concerning the plurality of character strings c31 to c34 are detected from the image 33.

The detecting unit 21 detects an attribute for each of the characters of the character strings c31 to c34 included in the respective plurality of image regions r31 to r34 (step S84). For example, as shown in FIG. 22C, the detecting unit 21 detects attributes of the characters e21 to e27 of the character string c33 and attributes of the characters e31 to e36 of the character string c34. The attribute is, for example, a character color. In the example, the characters e21 to e24 have a first attribute and the characters e25 to e27 and e31 to e36 have a second attribute. The first attribute is, for example, black (B) and the second attribute is, for example, red (R).

As shown in FIG. 22A, the characters e21 to e24 of the character string c33 represent item names of a management number (character string “ABCD”). The characters e25 to e27 of the character string c33 and the characters e31 to e36 of the character string c34 correspond to one management number. Therefore, it is desired that the characters e25 to e27 and the characters e31 to e36 are combined and the characters e21 to e24 and the characters e25 to e27 are divided. The characters e25 to e27 and the characters e31 to e36 are combined and the characters e21 to e24 and the characters e25 to e27 are divided by carrying out processing described below.

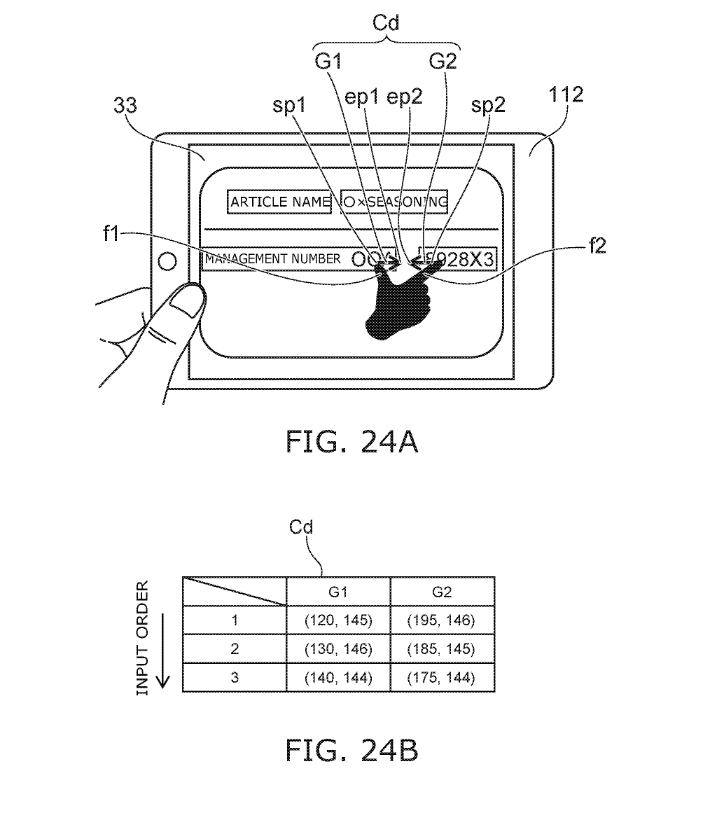

FIG. 24A and FIG. 24B are diagrams illustrating the operation of the receiving unit 22 according to the third embodiment.

FIG. 24A is a schematic view illustrating a coordinate input screen for an input to the receiving unit 22.

FIG. 24B is a diagram illustrating coordinate data representing a result of the input to the receiving unit 22.

In the example, the image 33 is displayed on a screen of an image processing apparatus 112. The image processing apparatus 112 includes, for example, a touch panel that enables touch operation on the screen.

The receiving unit 22 receives an input of coordinate information concerning coordinates in an image. In the embodiment, as shown in FIG. 24A, the user moves the fingers f1 and f2 to perform pinch-in operation on the image 33 displayed on the screen and inputs the coordinate information Cd. The coordinate information Cd includes the first coordinate group G1 and the second coordinate group G2. The first coordinate group G1 includes a plurality of coordinates continuously designated in the image 33. The second coordinate group G2 includes another plurality of coordinates continuously designated in the image 33. The plurality of coordinates of the first coordinate group G1 correspond to a track of the finger f1. The other plurality of coordinates of the second coordinate group G2 correspond to a track of the finger f2. The continuously designated plurality of coordinates mean, for example, a set of coordinates acquired in time series. The set of coordinates does not always have to be acquired in time series. The order of the set of coordinates only has to be specified.

As shown in FIG. 24B, the first coordinate group G1 includes, for example, in an input order, a plurality of coordinates (120, 145), (130, 146), and (140, 144). The first start point coordinate sp1 of the first coordinate group G1 is (120, 145). The first end point coordinate ep1 of the first coordinate group G1 is (140, 144). The second coordinate group G2 includes, for example, in an input order, a plurality of coordinates (195, 146), (185, 145), and (175, 144). The second start point coordinate sp2 of the second coordinate group G2 is (195, 146). The second end point coordinate ep2 of the second coordinate group G2 is (175, 144). As shown in FIG. 24A, a direction from the first start point coordinate sp1 to the first end point coordinate ep1 of the first coordinate group G1 is opposite to a direction from the second start point coordinate sp2 to the second end point coordinate ep2 of the second start point coordinate G2.

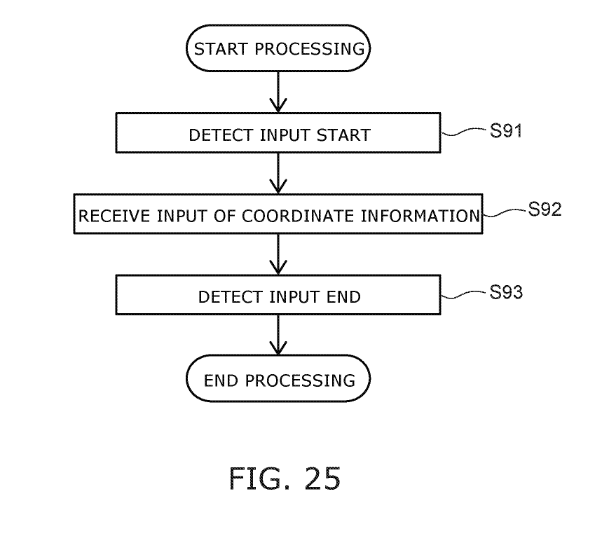

FIG. 25 is a flowchart for describing an operation example of the receiving unit 22 according to the second embodiment.

As shown in FIG. 25, the receiving unit 22 detects a trigger of a reception start of a coordinate input (step S91). For example, as shown in FIG. 24A and FIG. 24B, when the receiving unit 22 is configured to receive an input from the touch panel, the receiving unit 22 detects an event such as touch-down as the trigger. Consequently, the receiving unit 22 starts the reception of the coordinate input.

The receiving unit 22 receives an input of coordinate information according to operation by the user (step S92). Examples of touch operation by the user include pinch-in operation, pinch-out operation, tap operation, and drag operation. In FIG. 24A and FIG. 24B, the pinch-in operation is illustrated. Note that, instead of the touch operation, the user may input coordinate information using a pointing device such as a mouse.

The receiving unit 22 detects a trigger of a reception end of the coordinate input (step S93). For example, the receiving unit 22 detects an event such as touch-up as the trigger. Consequently, the receiving unit 22 ends the reception of the coordinate input.

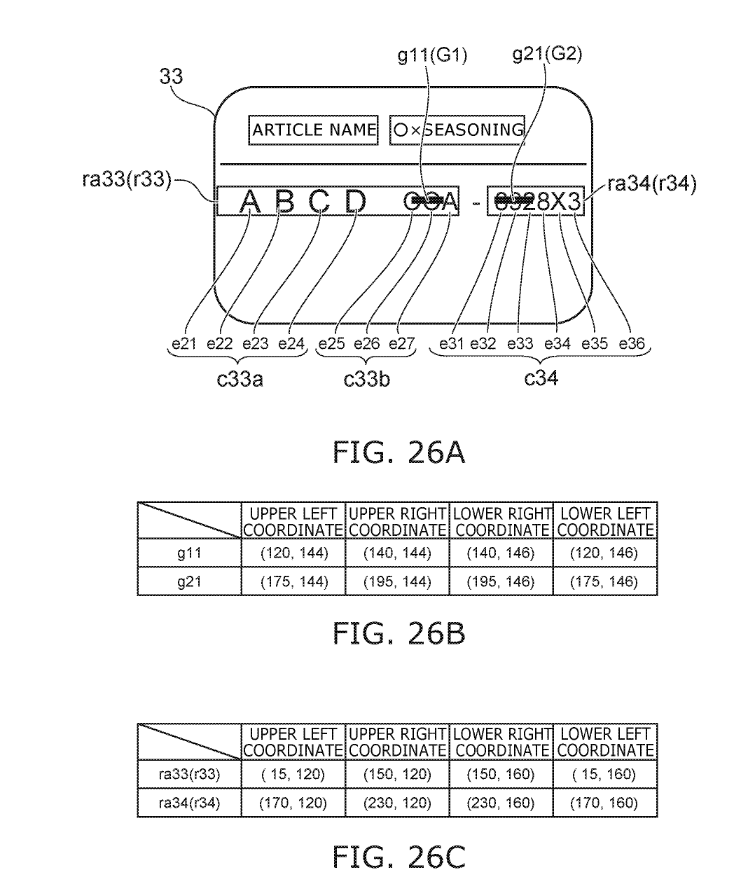

FIG. 26A to FIG. 26C are diagrams illustrating the operation of the extracting unit 23 according to the third embodiment.

FIG. 26A is a schematic view illustrating an image representing coordinate regions respectively corresponding to the first coordinate group G1 and the second coordinate group G2.

FIG. 26B is a diagram illustrating coordinate data representing the coordinate regions respectively corresponding to the first coordinate group G1 and the second coordinate group G2.

FIG. 26C is a diagram illustrating coordinate data representing an extraction result of the extracting unit 23.

The extracting unit 23 extracts, out of a plurality of image regions, designated regions designated by coordinate information. In the embodiment, as shown in FIG. 26A, two designated regions ra33 and ra34 are extracted out of the plurality of image regions r31 to r34 according to the coordinate region g11 and the coordinate region g21. The coordinate region g11 corresponds to the first coordinate group G1. The coordinate region g11 is configured by, for example, a bounding rectangle including coordinates of the first coordinate group G1. The coordinate region g21 corresponds to the second coordinate group G2. The coordinate region g21 is configured by, for example, a bounding rectangle including coordinates of the second coordinate group G2. The extracting unit 23 extracts, as designated regions, for example, image regions overlapping at least parts of the coordinate regions g11 and g21 among the plurality of image regions r31 to r34.

As shown in FIG. 26B, concerning the respective coordinate regions g11 and g21, upper left coordinates, upper right coordinates, lower right coordinates, and lower right coordinates are calculated. Note that respective coordinates of the coordinate regions g11 and g21 can be calculated from the coordinate information Cd (the first coordinate group G1 and the second coordinate group G2) shown in FIG. 24B.

As shown in FIG. 26C, concerning the respective two designated regions ra33 and ra34, upper left coordinates, upper right coordinates, lower right coordinates, and lower right coordinates are detected. The coordinates of the designated region ra33 are the same as the coordinates of the image region r33. The coordinates of the designated region ra34 are the same as the coordinates of the image region r34.

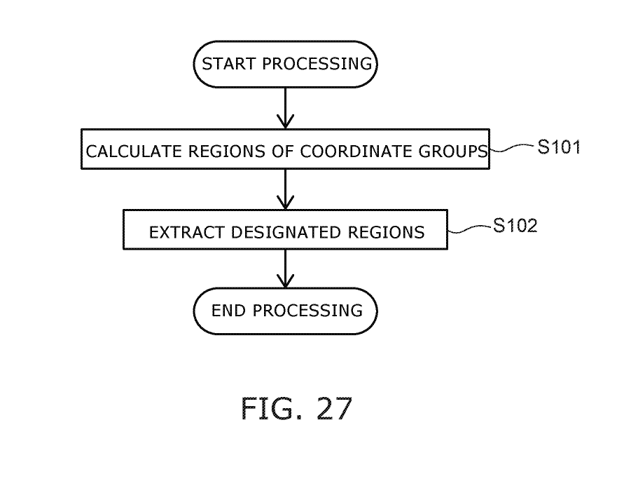

FIG. 27 is a flowchart for describing an operation example of the extracting unit 23 according to the third embodiment.

As shown in FIG. 27, the extracting unit 23 calculates coordinate regions respectively corresponding to the first coordinate group G1 and the second coordinate group G2 (step S101). As shown in FIG. 26A, the coordinate region g11 corresponds to the first coordinate group G1. The coordinate region g11 is configured by, for example, a bounding rectangle including coordinates of the first coordinate group G1. The coordinate region g21 corresponds to the second coordinate group G2. The coordinate region g21 is configured by, for example, a bounding rectangle including coordinates of the second coordinate group G2.

The extracting unit 23 extracts, out of the plurality of image regions r31 to r34, two designated regions ra33 and ra34 designated by the coordinate regions g11 and g21 (step S102). For example, the extracting unit 23 extracts, as designated regions, image regions overlapping at least parts of the coordinate regions g11 and g21 among the plurality of image regions r31 to r34. As shown in FIG. 26A and FIG. 26C, the two image regions r33 and r34 are extracted as the designated regions ra33 and r34 out of the plurality of image regions r31 to r34.

The designated region ra33 includes a first character string c33a and a second character string c33b. The first character string c33a includes the plurality of characters e21 to e24. The attribute of the plurality of characters e21 to e24 is the first attribute. The attribute is, for example, a character color. The first attribute is, for example, black (B). The second character string c33b includes the plurality of characters e25 to e27. The attribute of the plurality of characters e25 to e27 is the second attribute. The second attribute is, for example, red (R). The designated region ra34 includes the character string c34 (hereinafter, the third character string c34). The third character string c34 includes the plurality of characters e31 to e36. The attribute of the plurality of characters e31 to e36 is the second attribute (red (R)).

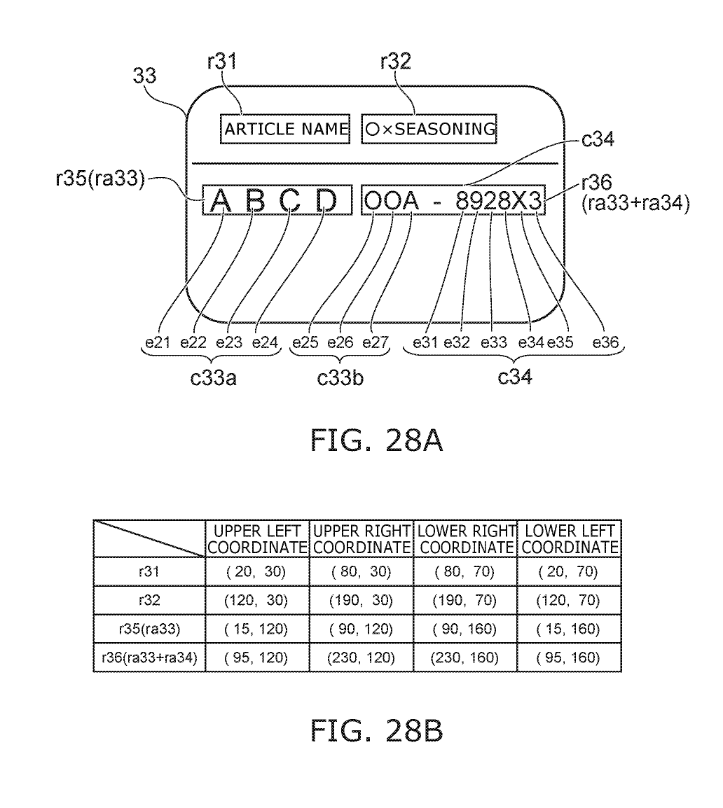

FIG. 28A and FIG. 28B are diagrams illustrating the operation of the generating unit 24 according to the third embodiment.

FIG. 28A is a schematic view illustrating an image representing a generation result of the generating unit 24.

FIG. 28B is a diagram illustrating coordinate data representing the generation result of the generating unit 24.

The generating unit 24 generates, on the basis of coordinate information, corrected regions obtained by correcting at least one of the number and the size of designated regions. In the embodiment, as shown in FIG. 28A, the generating unit 24 combines a part of the designated region ra33 and the designated region ra34 based on the first coordinate group G1 and the second coordinate group G2. That is, the second character string c33b having the second attribute and the third character string c34 having the second attribute are combined. The first character string c33a having the first attribute and the second character string c33b having the second attribute are divided. The attribute is, for example, a character color. Consequently, a corrected region r35 including the first character string c33a having the first attribute and a corrected region r36 including the second character string c33b and the third character string c34 having the second attribute are generated. The corrected region r35 is configured as, for example, a bounding rectangle including coordinates of one of two divided regions of the designated region ra33. The corrected region r36 is configured as, for example, a bounding rectangle including coordinates of the other of the two divided regions of the designated region ra33 and coordinates of the designated region ra34.

As shown in FIG. 28B, upper left coordinates, upper right coordinates, lower right coordinates, and lower left coordinates of the respective corrected regions r35 and r36 are detected. The upper left coordinate, the upper right coordinate, the lower right coordinate, and the lower left coordinate of the corrected region r35 are respectively (15, 120), (90, 120), (90, 160), and (15, 160). The upper left coordinate, the upper right coordinate, the lower right coordinate, and the lower left coordinate of the corrected region r36 are respectively (95, 120), (230, 120), (230, 160), and (95, 160)

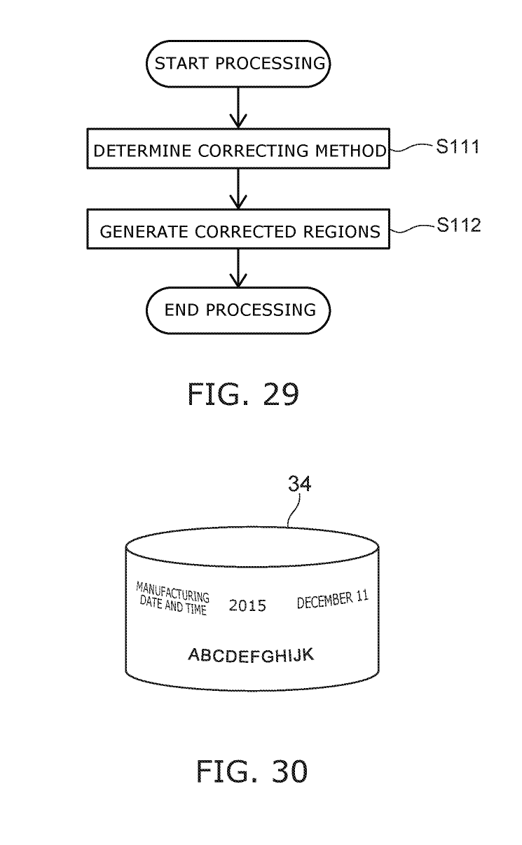

FIG. 29 is a flowchart for describing an operation example of the generating unit 24 according to the third embodiment.

As shown in FIG. 29, the generating unit 24 determines a correcting method using the classification table 25 (FIG. 11) (step S111). As described above, the first start point coordinate sp1 of the first coordinate group G1 is (120, 145). The first end point coordinate ep1 of the first coordinate group G1 is (140, 144). The second start point coordinate sp2 of the second coordinate group G2 is (195, 146). The second end point coordinate ep2 of the second coordinate group G2 is (175, 144). The generating unit 24 calculates an inter-start point coordinate distance and an inter-end point coordinate distance from the start point coordinates and the end point coordinates. The generating unit 24 calculates the distances using only X coordinates.

The inter-start point coordinate distance between the first start point coordinate sp1 (120, 145) of the first coordinate group G1 and the second start point coordinate sp2 (195, 146) of the second coordinate group G2 is calculated as 195−120=75. The inter-end point coordinate distance between the first end point coordinate ep1 (140, 144) of the first coordinate group G1 and the second end point coordinate ep2 (175, 144) of the second coordinate group G2 is calculated as 175−40=30. Therefore, there is a relation of the inter-start point coordinate distance>the inter-end point coordinate distance. As shown in FIG. 24A, a direction from the first start point coordinate sp1 to the first end point coordinate ep1 of the first coordinate group G1 is opposite to a direction from the second start point coordinate sp2 to the second end point coordinate ep2 of the second coordinate group G2. That is, it is recognized that the operation by the user is the pinch-in operation.

The generating unit 24 determines a correcting method referring to the classification table 25 shown in FIG. 11. In the embodiment, the number of designated regions is “2”, the number of input coordinates is “2”, the distance is “reduced”, the direction is “opposite”, and the positional relation is “partially included”. Consequently, when the classification table 25 is referred to, the correcting method is determined as the combination.

As shown in FIG. 28A, the generating unit 24 combines the two designated regions ra33 and ra34 on the basis of the correcting method determined in step S111. At this point, the generating unit 24 combines a part of the designated region ra33 and the designated region ra34 on the basis of the attributes and generates the two corrected regions r27 and r28 (step S112). In the embodiment, a part (the second character string c33b) of the designated region ra33 and the designated region ra34 (the third character string c34) are combined. That is, in the designated region ra33 and the designated region ra34, the character strings having the same attribute are combined. The attribute is, for example, a character color. According to the example shown in FIG. 22C, the character color of the characters e21 to e24 is black (B). The character color of the characters e25 to e27 and e31 to e36 is red (R). Therefore, the second character string c33b including the characters e25 to e27 and the third character string c34 including the characters e31 to e36 are combined. The first character string c33a including the characters e21 to e24 and the second character strings c33b including the characters e25 to e27 are divided.

The image processing apparatus 112 according to the embodiment detects a plurality of image regions serving as reading regions from an image. The image processing apparatus 112 corrects, according to the operation (pinch-in, etc.) by the user and the attributes, image regions where characters are excessive or insufficient and desired character strings are not formed among the plurality of image regions and generates image regions composed of the desired character strings. Consequently, even in the case of a character string in which a plurality of words are not linearly arranged, a character string in which a plurality of words are complicatedly arranged, and the like, it is possible to efficiently read characters with simple operation.

### Fourth Embodiment

FIG. 30 is a schematic view illustrating an image according to a fourth embodiment.

As shown in FIG. 30, the acquiring unit 10 acquires an image 34. The image 34 includes a plurality of character strings. Among the plurality of character strings, a manufacturing date and time corresponds to an input item.

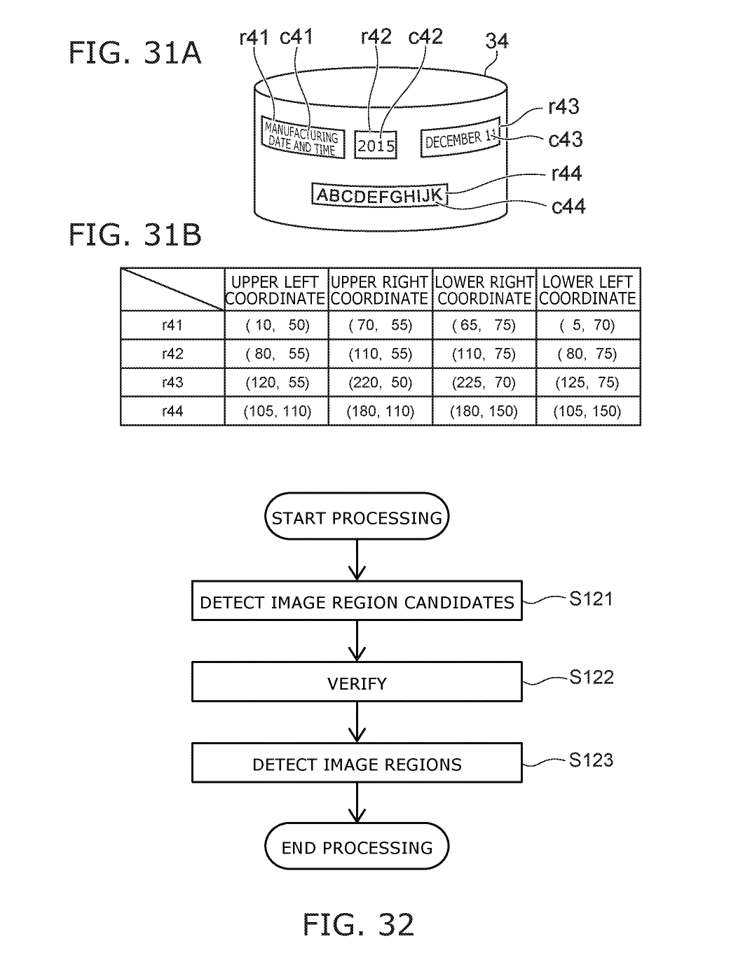

FIG. 31A and FIG. 31B are diagrams illustrating the operation of the detecting unit 21 according to the fourth embodiment.

FIG. 31A is a schematic view illustrating an image representing a detection result of the detecting unit 21.

FIG. 31B is a diagram illustrating coordinate data representing the detection result of the detecting unit 21.

The detecting unit 21 detects a plurality of image regions concerning a plurality of character strings from an image. In the embodiment, as shown in FIG. 31A, the detecting unit 21 detects a plurality of image regions r41 to r44 concerning a plurality of character strings c41 to c44 from an image 34. The respective plurality of image regions r41 to r44 are regions set as reading targets of character strings. The respective plurality of image regions r41 to r44 are illustrated as rectangular regions. The plurality of image regions r41 to r44 may be indicated by frame lines or the like surrounding character strings to enable a user to visually recognize the plurality of image regions r41 to r44 on a screen.

As shown in FIG. 31B, concerning the respective plurality of image regions r41 to r44, upper left coordinates, upper right coordinates, lower right coordinates, and lower right coordinates are detected. Note that, in the example, a coordinate of the image 34 is represented by an XY coordinate with an upper left corner of the image 34 set as a reference (0, 0). An X coordinate is a coordinate in a lateral direction of the image 34 and is represented, for example, in a range of 0 to 400 from the left to the right. A Y coordinate is a coordinate in a longitudinal direction of the image 34 and is represented, for example, in a range of 0 to 300 from up to down.

FIG. 32 is a flowchart for describing an operation example of the detecting unit 21 according to the fourth embodiment.

As shown in FIG. 32, the detecting unit 21 detects a plurality of image region candidates from the image 34 (step S121). The respective plurality of image region candidates include character string candidates. The detecting unit 21 analyzes the image 34 and detects the sizes and the positions of respective character candidates configuring the character string candidates. Specifically, for example, there is a method of generating pyramid images having various resolutions with respect to an analysis target image and identifying whether rectangles having a fixed size obtained by segmenting the pyramid images in a licking manner are character candidates. As feature values used for the identification, for example, Joint Haar-like features are used. As a classifier, for example, an Adaptive Boosting algorithm is used. Consequently, it is possible to detect image region candidates at high speed.

The detecting unit 21 verifies whether the image region candidates detected in step S121 include true characters (step S122). For example, there is a method of discarding image region candidates not determined as characters using a classifier such as a Support Vector Machine.

The detecting unit 21 sets, as a character string, a combination of the image region candidates arranged side by side as one character string candidate among the image region candidates not discarded in step S122 and detects an image region including the character string (step S123). Specifically, the detecting unit 21 votes on a (θ-ρ) space representing line parameters using a method such as Hough transform and determines, as a character string, a set of character candidates (a character string candidate) configuring line parameters of voting frequencies.

In this way, the plurality of image regions r41 to r44 concerning the plurality of character strings c41 to c44 are detected from the image 34.

As shown in FIG. 31A, the character strings c42 and c43 correspond to one manufacturing date and time. Therefore, the image regions r42 and r43 including the character strings c42 and c43 are desirably combined into one image region. The two image regions r42 and r43 are combined into one image region by carrying out processing described below.

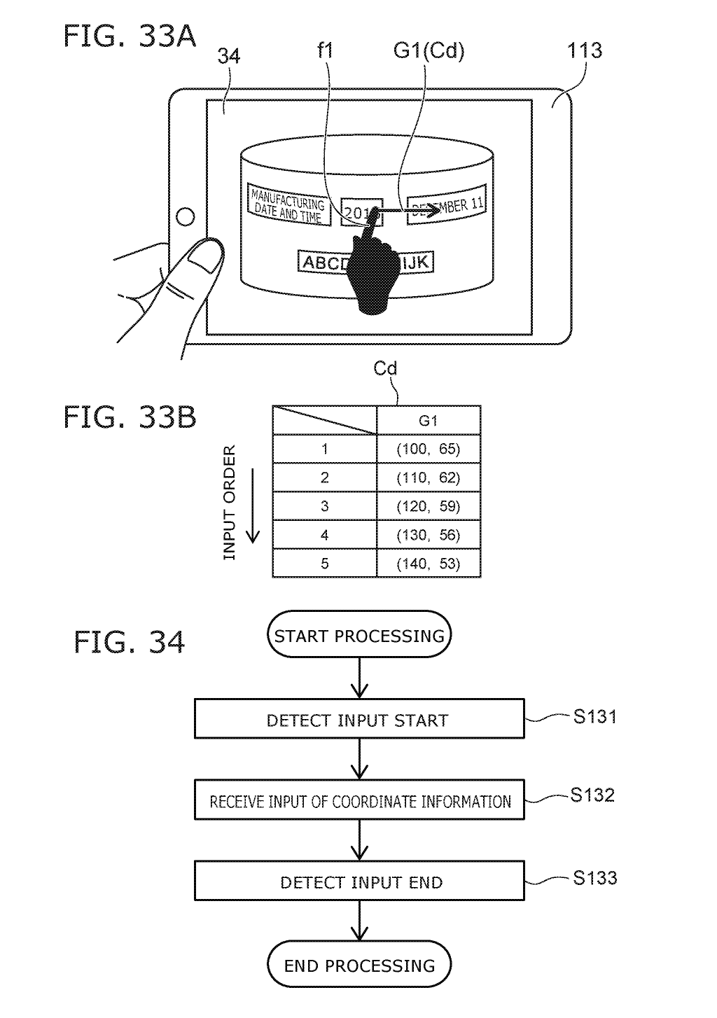

FIG. 33A and FIG. 33B are diagrams illustrating the operation of the receiving unit 22 according to the fourth embodiment.

FIG. 33A is a schematic view illustrating a coordinate input screen for an input to the receiving unit 22.

FIG. 33B is a diagram illustrating coordinate data representing a result of the input to the receiving unit 22.

In the example, the image 34 is displayed on a screen of an image processing apparatus 113. The image processing apparatus 113 includes, for example, a touch panel that enables touch operation on the screen.

The receiving unit 22 receives an input of coordinate information concerning coordinates in an image. In the embodiment, as shown in FIG. 33A, the user moves the finger f1 with respect to the image 34 displayed on the screen to perform drag operation and inputs the coordinate information Cd. The drag operation is an operation method for moving the one finger f1 in contact with the screen in one direction to trace the screen. The coordinate information Cd includes the first coordinate group G1. The first coordinate group G1 includes a plurality of coordinates continuously designated in the image 34. The plurality of coordinates of the first coordinate group G1 correspond to a track of the finger f1.

As shown in FIG. 33B, the first coordinate group G1 includes, for example, in an input order, a plurality of coordinates (100, 65), (100, 62), (120, 59), (130, 56), and (140, 53). A start point coordinate of the first coordinate group G1 is (100, 65). An end point coordinate of the first coordinate group G1 is (140, 53).

FIG. 34 is a flowchart for describing an operation example of the receiving unit 22 according to the fourth embodiment.

As shown in FIG. 34, the receiving unit 22 detects a trigger of a reception start of a coordinate input (step S131). For example, as shown in FIG. 33A and FIG. 33B, when the receiving unit 22 is configured to receive an input from the touch panel, the receiving unit 22 detects an event such as touch-down as the trigger. Consequently, the receiving unit 22 starts the reception of the coordinate input.

The receiving unit 22 receives an input of coordinate information according to operation by the user (step S132). Examples of touch operation by the user include pinch-in operation, pinch-out operation, tap operation, and drag operation. In FIG. 33A and FIG. 33B, the drag operation is illustrated. Note that, instead of the touch operation, the user may input coordinate information using a pointing device such as a mouse.

The receiving unit 22 detects a trigger of a reception end of the coordinate input (step S133). For example, the receiving unit 22 detects an event such as touch-up as the trigger. Consequently, the receiving unit 22 ends the reception of the coordinate input.

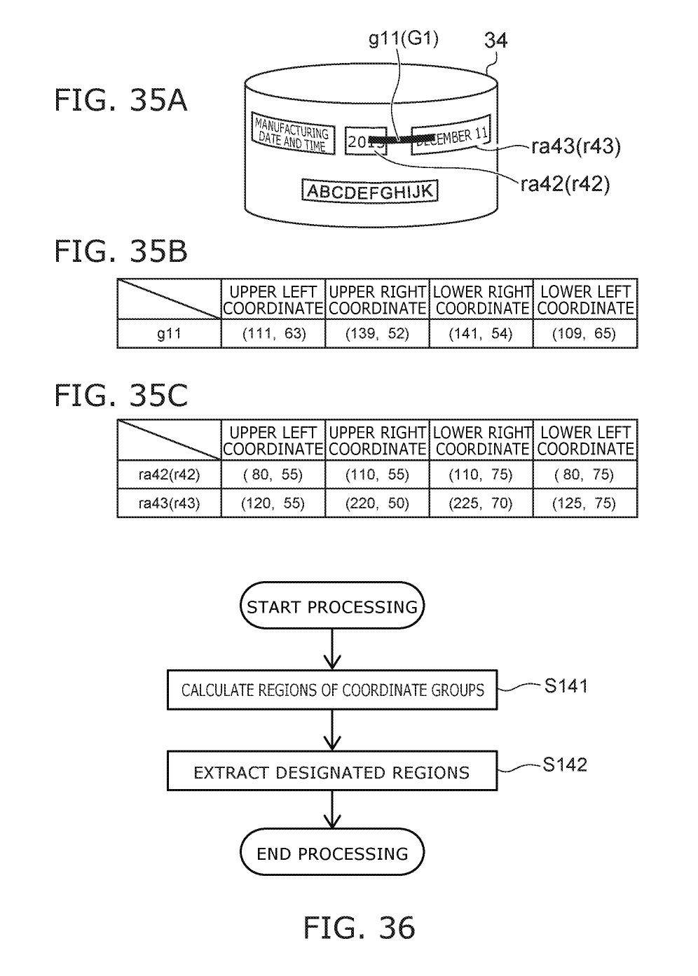

FIG. 35A to FIG. 35C are diagrams illustrating the operation of the extracting unit 23 according to the fourth embodiment.

FIG. 35A is a schematic view illustrating an image representing a coordinate region corresponding to the first coordinate group G1.

FIG. 35B is a diagram illustrating coordinate data representing the coordinate region corresponding to the first coordinate group G1.

FIG. 35C is a diagram illustrating coordinate data representing an extraction result of the extracting unit 23.

The extracting unit 23 extracts, out of a plurality of image regions, designated regions designated by coordinate information. In the embodiment, as shown in FIG. 35A, two designated regions ra42 and ra43 are extracted out of the plurality of image regions r41 to r44 according to the coordinate region g11. The coordinate region g11 corresponds to the first coordinate group G1. The coordinate region g11 is configured by, for example, a bounding rectangle including coordinates of the first coordinate group G1. The extracting unit 23 extracts, as designated regions, for example, image regions overlapping at least a part of the coordinate region g11 among the plurality of image regions r1 to r12.

As shown in FIG. 35B, concerning the coordinate region g11, an upper left coordinate, an upper right coordinate, a lower right coordinate, and a lower right coordinate are calculated. Note that the coordinates of the coordinate region g11 can be calculated from the coordinate information Cd (the first coordinate group G1) shown in FIG. 33B.

As shown in FIG. 35C, concerning the respective two designated regions ra42 to ra43, upper left coordinates, upper right coordinates, lower right coordinates, and lower right coordinates are detected. The respective coordinates of the two designated regions ra42 and ra43 are the same as the respective coordinates of the two image regions r42 and r43.

FIG. 36 is a flowchart for describing an operation example of the extracting unit 23 according to the fourth embodiment.

As shown in FIG. 36, the extracting unit 23 calculates a coordinate region corresponding to the first coordinate group G1 (step S141). As shown in FIG. 35A, the coordinate region g11 corresponds to the first coordinate group G1. The coordinate region g11 is configured by, for example, a bounding rectangle including coordinates of the first coordinate group G1.

The extracting unit 23 extracts, out of the plurality of image regions r41 to r44, the two designated regions ra42 and ra43 designated by the coordinate region g11 (step S142). For example, the extracting unit 23 extracts, as designated regions, image regions overlapping at least a part of the coordinate region g11 among the plurality of image regions r41 to r44. As shown in FIG. 35A and FIG. 35C, the two image regions r42 and r43 are extracted as the designated regions ra42 and ra43 out of the plurality of image regions r41 to r44.

The start point coordinate (100, 65) of the first coordinate group G1 is located at a rear end portion of the designated region ra42. The end point coordinate (140, 53) of the first coordinate group G1 is located at a front end portion of the designated region ra43.

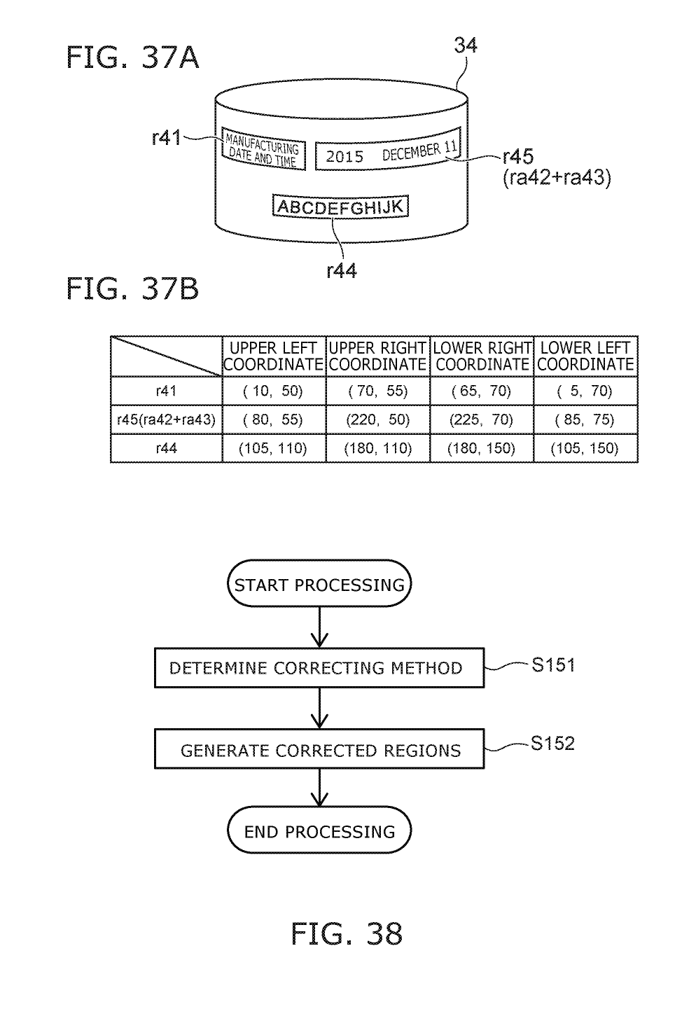

FIG. 37A and FIG. 37B are diagrams illustrating the operation of the generating unit 24 according to the fourth embodiment.

FIG. 37A is a schematic view illustrating an image representing a generation result of the generating unit 24.

FIG. 37B is a diagram illustrating coordinate data representing the generation result of the generating unit 24.

The generating unit 24 generates, on the basis of coordinate information, corrected regions obtained by correcting at least one of the number and the size of designated regions. In the embodiment, as shown in FIG. 37A, the generating unit 24 combines the two designated regions ra42 and ra43 on the basis of the first coordinate group G1 and generates one corrected region r45. The corrected region r45 is configured as, for example, a bounding rectangle including coordinates of the two designated regions ra42 and ra43.

As shown in FIG. 37B, an upper left coordinate, an upper right coordinate, a lower right coordinate, and a lower left coordinate of the corrected region r45 are detected. The upper left coordinate, the upper right coordinate, the lower right coordinate, and the lower left coordinate are respectively (80, 55), (220, 50), (225, 70), and (85, 75).

FIG. 38 is a flowchart for describing an operation example of the generating unit 24 according to the fourth embodiment.

As shown in FIG. 38, the generating unit 24 determines a correcting method using the classification table 25 (FIG. 11) (step S151). In the embodiment, the number of designated regions is “2” and the number of input coordinates is “1”. Consequently, when the classification table 25 is referred to, the correcting method is determined as the combination.

As shown in FIG. 37A, the generating unit 24 combines the two designated regions ra42 and ra43 on the basis of the correcting method determined in step S151 and generates one corrected region r45 (step S152).

In the embodiment, the start point coordinate of the first coordinate group G1 is located at the rear end portion of the designated region ra42. The end point coordinate of the first coordinate group G1 is located at the front end portion of the designated region ra43. That is, it is unnecessary to drag all of the designated regions ra42 and ra43 and designate reading regions. Therefore, compared with the reference example described above, it is possible to designate the reading regions with simpler operation.

The image processing apparatus 113 according to the embodiment detects a plurality of image regions serving as reading regions from an image. The image processing apparatus 113 corrects, according to the operation (drag, etc.) by the user, image regions where characters are excessive or insufficient and desired character strings are not formed among the plurality of image regions and generates image regions composed of the desired character strings. Consequently, even in the case of a character string in which a plurality of words are not linearly arranged, a character string in which a plurality of words are complicatedly arranged, and the like, it is possible to efficiently read characters with simple operation.

### Fifth Embodiment

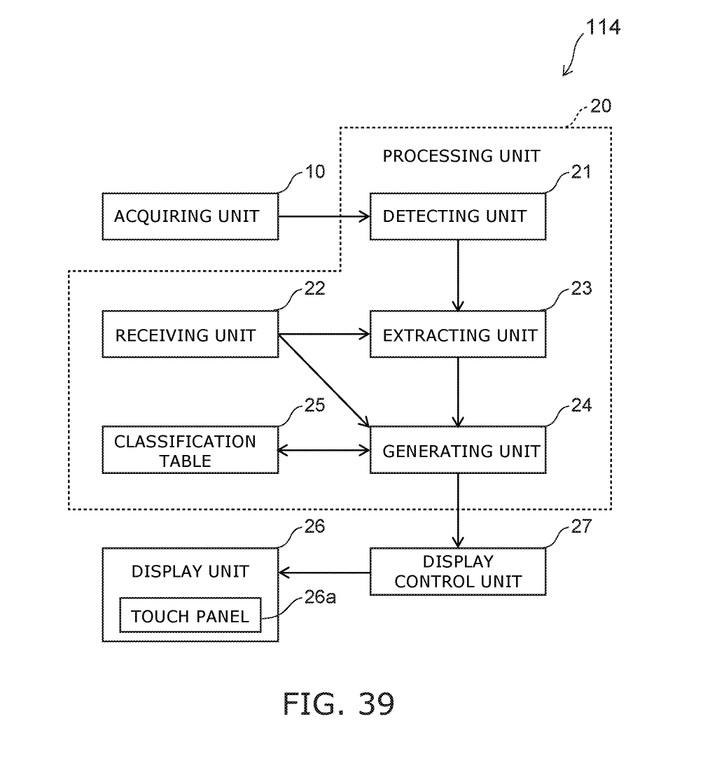

FIG. 39 is a block diagram illustrating an image processing apparatus according to a fifth embodiment.

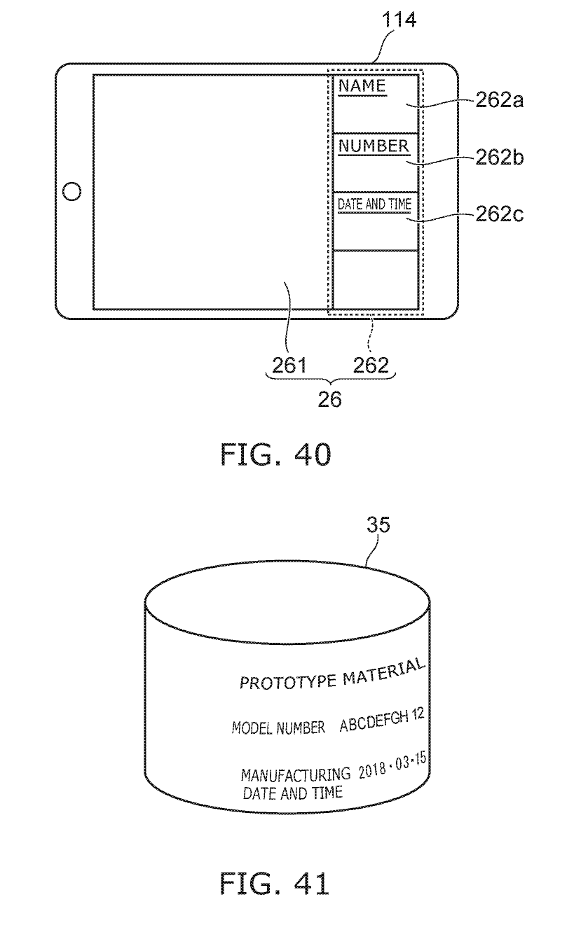

FIG. 40 is a schematic view illustrating a screen of a display unit of the image processing apparatus.

An image processing apparatus 114 according to the embodiment includes, as shown in FIG. 39, the acquiring unit 10 and the processing unit 20 and further includes a display unit 26 and a display control unit 27. As the display unit 26, for example, a liquid crystal display integrally including a touch panel 26a is used. The display control unit 27 controls display of the display unit 26. Basic configurations of the acquiring unit 10 and the processing unit 20 are the same as the basic configurations in the image processing apparatus 110 shown in FIG. 1.

As shown in FIG. 40, the display unit 26 includes a first display region 261 and a second display region 262. The first display region 261 is a preview display region for displaying an image and the like. The second display region 262 is an information display region for displaying various kinds of information concerning the image. The second display region 262 includes, for example, a name display field 262a, a number display field 262b, and a date and time display field 262c. The name display field 262a, the number display field 262b, and the date and time display field 262c can be selected by touch operation of the user. Information corresponding to the selected display field is displayed.

FIG. 41 is a schematic view illustrating an image according to a fifth embodiment.

As shown in FIG. 41, the acquiring unit 10 acquires an image 35. The image 35 includes a plurality of character strings. Among the plurality of character strings, a model number and a manufacturing date and time respectively correspond to input items.

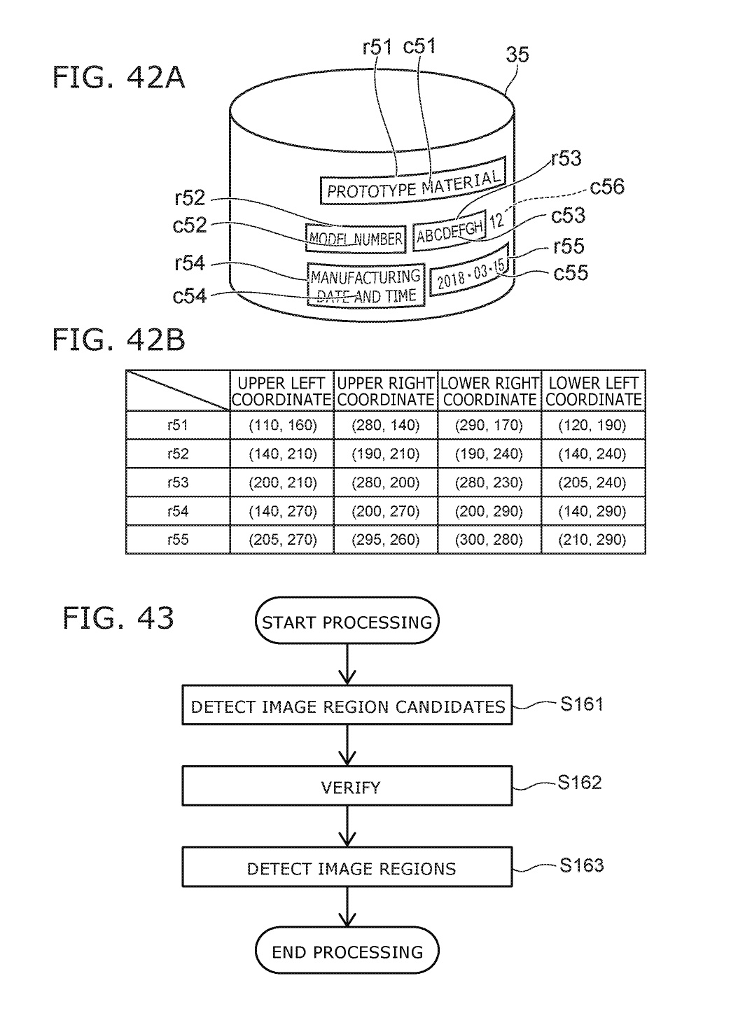

FIG. 42A and FIG. 42B are diagrams illustrating the operation of the detecting unit 21 according to the fifth embodiment.

FIG. 42A is a schematic view illustrating an image representing a detection result of the detecting unit 21.

FIG. 42B is a diagram illustrating coordinate data representing the detection result of the detecting unit 21.

The detecting unit 21 detects a plurality of image regions concerning a plurality of character strings from an image. In the embodiment, as shown in FIG. 42A, the detecting unit 21 detects a plurality of image regions r51 to r55 concerning a plurality of character strings c51 to c55 from an image 35. The respective plurality of image regions r51 to r55 are regions set as reading targets of character strings. The respective plurality of image regions r51 to r55 are illustrated as rectangular regions. The plurality of image regions r51 to r55 may be indicated by frame lines or the like surrounding character strings to enable a user to visually recognize the plurality of image regions r51 to r55 on a screen.

As shown in FIG. 42B, concerning the respective plurality of image regions r51 to r55, upper left coordinates, upper right coordinates, lower right coordinates, and lower right coordinates are detected. Note that, in the example, a coordinate of the image 35 is represented by an XY coordinate with an upper left corner of the image 35 set as a reference (0, 0). An X coordinate is a coordinate in a lateral direction of the image 35 and is represented, for example, in a range of 0 to 400 from the left to the right. A Y coordinate is a coordinate in a longitudinal direction of the image 35 and is represented, for example, in a range of 0 to 300 from up to down.

FIG. 43 is a flowchart for describing an operation example of the detecting unit 21 according to the fifth embodiment.

As shown in FIG. 43, the detecting unit 21 detects a plurality of image region candidates from the image 35 (step S161). The respective plurality of image region candidates include character string candidates. The detecting unit 21 analyzes the image 35 and detects the sizes and the positions of respective character candidates configuring the character string candidates. Specifically, for example, there is a method of generating pyramid images having various resolutions with respect to an analysis target image and identifying whether rectangles having a fixed size obtained by segmenting the pyramid images in a licking manner are character candidates. As feature values used for the identification, for example, Joint Haar-like features are used. As a classifier, for example, an Adaptive Boosting algorithm is used. Consequently, it is possible to detect image region candidates at high speed.

The detecting unit 21 verifies whether the image region candidates detected in step S161 include true characters (step S162). For example, there is a method of discarding image region candidates not determined as characters using a classifier such as a Support Vector Machine.

The detecting unit 21 sets, as a character string, a combination of the image region candidates arranged side by side as one character string candidate among the image region candidates not discarded in step S162 and detects an image region including the character string (step S163). Specifically, the detecting unit 21 votes on a (θ-ρ) space representing line parameters using a method such as Hough transform and determines, as a character string, a set of character candidates (a character string candidate) configuring line parameters of voting frequencies.

In this way, the plurality of image regions r51 to r55 concerning the plurality of character strings c51 to c55 are detected from the image 35.

As shown in FIG. 42A, the character string c53 and a character string c56 correspond to one model number. The character string c56 is a part of the model number but is not detected as an image region and is not set as a reading target. Therefore, it is desired to increase the size of the image region r53 and include the character string c53 and the character string c56 in one image region. The size of the image region r53 is increased by carrying out processing described below.

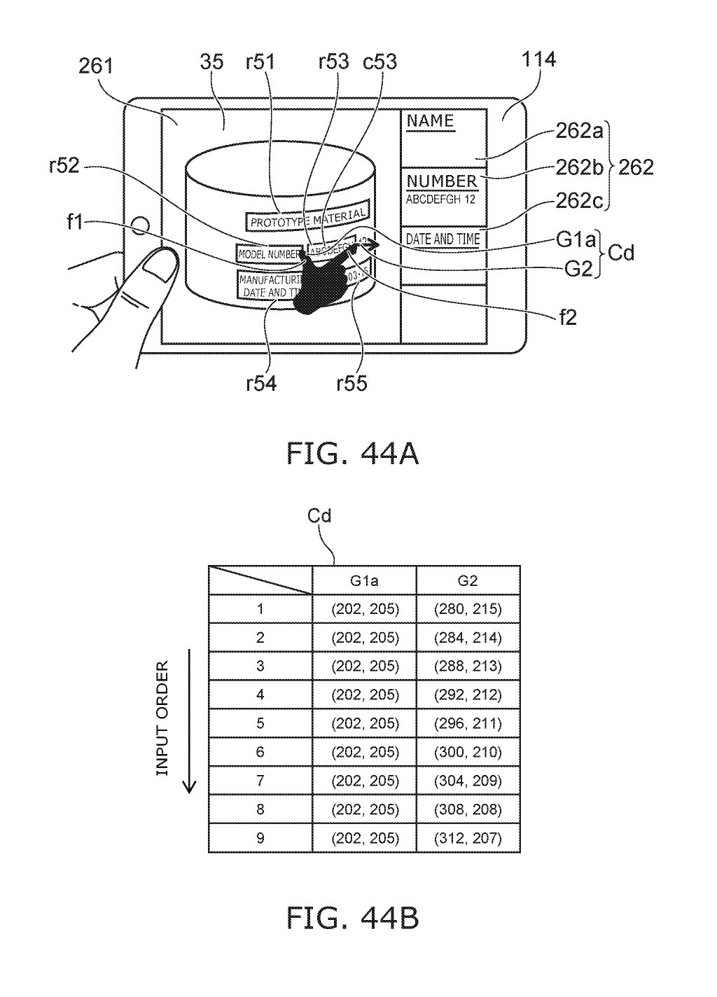

FIG. 44A and FIG. 44B are diagrams illustrating the operation of the receiving unit 22 according to the fifth embodiment.

FIG. 44A is a schematic view illustrating a coordinate input screen for an input to the receiving unit 22.

FIG. 44B is a diagram illustrating coordinate data representing a result of the input to the receiving unit 22.

In the example, the image 35 is displayed on a screen of the image processing apparatus 114. The image processing apparatus 114 includes, for example, a touch panel that enables touch operation on the screen.

The receiving unit 22 receives an input of coordinate information concerning coordinates in an image. In the embodiment, as shown in FIG. 44A, the user fixes the finger f1 and moves the finger f2 with respect to the image 35 displayed on the screen to perform pinch-out operation fixed at one point and inputs the coordinate information Cd. The pinch-out operation fixed at one point is an operation method for fixing one of the two fingers f1 and f2 in contact with the screen and moving the other finger to increase the distance between the two fingers f1 and f2. The coordinate information Cd includes a first coordinate G1a and the second coordinate group G2. The first coordinate G1a is one coordinate designated in the image 35. The second coordinate group G2 includes another plurality of coordinates continuously designated in the image 35. The first coordinate G1a corresponds to a fixed position of the finger f1. The other plurality of coordinates of the second coordinate group G2 correspond to a track of the finger f2.

As shown in FIG. 44B, as the first coordinate G1a, for example, a plurality of same coordinates (202, 205) are continuously input. The second coordinate group G2 includes, for example, in an input order, a plurality of coordinates (280, 215), (284, 214), (288, 213), (292, 212), (296, 211), (300, 210), (304, 209), (308, 208), and (312, 207). A start point coordinate of the second coordinate group G2 is (280, 215). An end point coordinate of the second coordinate group G2 is (312, 207).

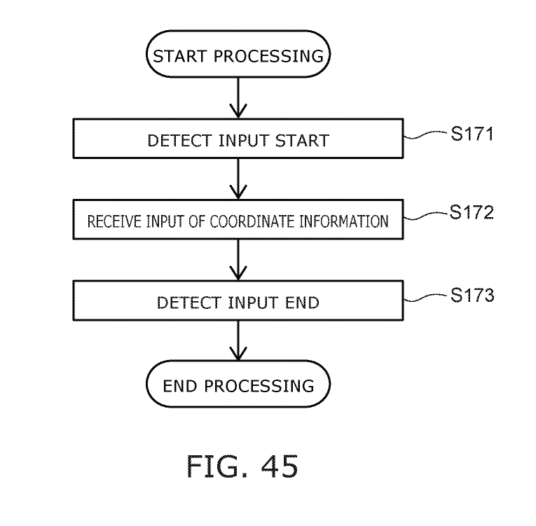

FIG. 45 is a flowchart for describing an operation example of the receiving unit 22 according to the fifth embodiment.

As shown in FIG. 45, the receiving unit 22 detects a trigger of a reception start of a coordinate input (step S171). For example, as shown in FIG. 44A and FIG. 44B, when the receiving unit 22 is configured to receive an input from the touch panel, the receiving unit 22 detects an event such as touch-down as the trigger. Consequently, the receiving unit 22 starts the reception of the coordinate input.

The receiving unit 22 receives an input of coordinate information according to operation by the user (step S172). In FIG. 44A and FIG. 44B, the pinch-out operation fixed at one point is illustrated. Note that, instead of the touch operation, the user may input coordinate information using a pointing device such as a mouse.

As shown in FIG. 44A, in the first display region 261, the image 35 and the plurality of image regions r51 to r55 are displayed. In the example, the image region r53 is designated by the touch operation by the user. In this case, the number display field 262b corresponding to the image region r53 is selected. In the number display field 262b, the character string c53 of the image region r53 is displayed.

The receiving unit 22 detects a trigger of a reception end of the coordinate input (step S173). For example, the receiving unit 22 detects an event such as touch-up as the trigger. Consequently, the receiving unit 22 ends the reception of the coordinate input.

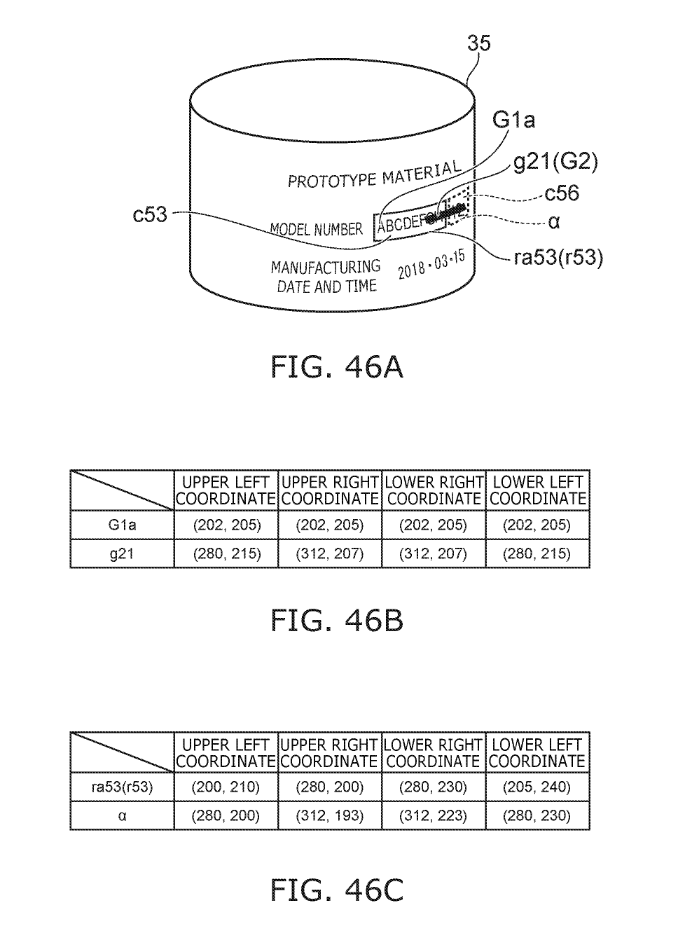

FIG. 46A to FIG. 46C are diagrams illustrating the operation of the extracting unit 23 according to the fifth embodiment.

FIG. 46A is a schematic view illustrating an image representing coordinate regions corresponding to the first coordinate G1a and the second coordinate group G2.

FIG. 46B is a diagram illustrating coordinate data representing the coordinate regions corresponding to the first coordinate G1a and the second coordinate group G2.

FIG. 46C is a diagram illustrating coordinate data representing an extraction result of the extracting unit 23.

The extracting unit 23 extracts, out of a plurality of image regions, designated regions designated by coordinate information. In the embodiment, as shown in FIG. 46A, one designated region ra53 is extracted out of the plurality of image regions r51 to r55 according to the first coordinate G1a and the coordinate region g21. The coordinate region g21 corresponds to the second coordinate group G2. The coordinate region g21 is configured by, for example, a bounding rectangle including coordinates of the second coordinate group G2. The extracting unit 23 extracts, as designated regions, for example, image regions overlapping at least parts of the first coordinate G1a and the coordinate region g21 among the plurality of image regions r51 to r55.

As shown in FIG. 46B, concerning the coordinate region g21, an upper left coordinate, an upper right coordinate, a lower right coordinate, and a lower right coordinate are calculated. Note that respective coordinates of the coordinate region g21 can be calculated from the coordinate information Cd (the second coordinate group G2) shown in FIG. 44B.

As shown in FIG. 46C, concerning the designated region ra53, an upper left coordinate, an upper right coordinate, a lower right coordinate, and a lower right coordinate are detected. The coordinates of the designated region ra53 are the same as the coordinates of the image region r53. In the embodiment, the size of the designated region ra53 is increased to include the character string c56. An enlarged portion of the designated region ra53 is set as an additional region α. Concerning the additional region α, an upper left coordinate, an upper right coordinate, a lower right coordinate, and a lower right coordinate are detected. The coordinates of the additional region α are determined on the basis of the coordinate region g21.

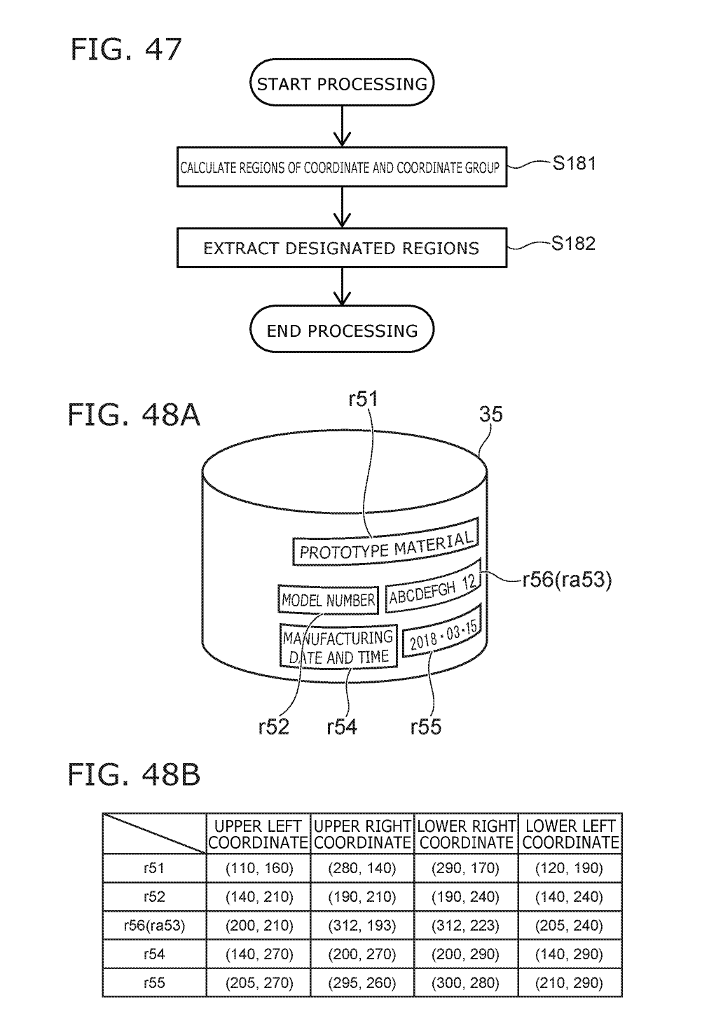

FIG. 47 is a flowchart for describing an operation example of the extracting unit 23 according to the fifth embodiment.

As shown in FIG. 47, the extracting unit 23 calculates coordinate regions respectively corresponding to the first coordinate G1a and the second coordinate group G2 (step S181). As shown in FIG. 46A, the coordinate region g21 corresponds to the second coordinate group G2. The coordinate region g21 is configured by, for example, a bounding rectangle including coordinates of the second coordinate group G2.

The extracting unit 23 extracts, out of the image regions r51 to r55, the one designated region ra53 designated by the first coordinate G1a and the coordinate region g12 (step S182). For example, the extracting unit 23 extracts, as designated regions, image regions overlapping at least parts of the first coordinate G1a and the coordinate region g21 among the plurality of image regions r51 to r55. As shown in FIG. 46A and FIG. 46C, the image region r53 is extracted as the designated region ra53 out of the plurality of image regions r51 to r55. The designated region ra53 is enlarged according to the coordinate region g21. Therefore, an enlarged portion of the designated region ra53 is set anew as the additional region α.

In the embodiment, the coordinate region g21 is designated to include the character string c56. For example, the one designated region ra53 is enlarged to an end point coordinate of the coordinate region g21. The end point coordinate of the coordinate region g21 corresponds to the position of the last character of the character string c56.

FIG. 48A and FIG. 48B are diagrams illustrating the operation of the generating unit 24 according to the fifth embodiment.

FIG. 48A is a schematic view illustrating an image representing a generation result of the generating unit 24.

FIG. 48B is a diagram illustrating coordinate data representing the generation result of the generating unit 24.

The generating unit 24 generates, on the basis of coordinate information, corrected regions obtained by correcting at least one of the number and the size of designated regions. In the embodiment, as shown in FIG. 48A, the generating unit 24 enlarges the one designated region ra53 on the basis of the first coordinate G1a and the second coordinate group G2 and generates one corrected region r56. The designated region ra53 after the enlargement includes the character string c56. The corrected region r56 is configured as, for example, a bounding rectangle including coordinates of the designated region ra53 after the enlargement.

As shown in FIG. 48B, an upper left coordinate, an upper right coordinate, a lower right coordinate, and a lower left coordinate of the corrected region r56 are detected. The upper left coordinate, the upper right coordinate, the lower right coordinate, and the lower left coordinate are respectively (200, 210), (312, 193), (312, 223), and (205, 240).

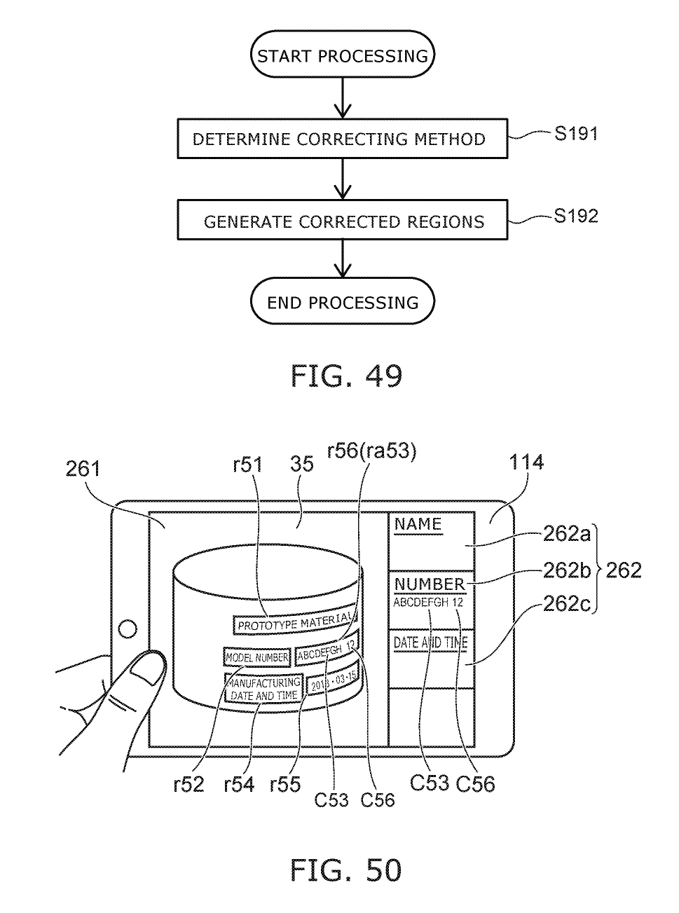

FIG. 49 is a flowchart for describing an operation example of the generating unit 24 according to the fifth embodiment.

As shown in FIG. 49, the generating unit 24 determines a correcting method using the classification table 25 (step S191). As described above, the coordinate of the first coordinate G1a is (202, 205). The start point coordinate of the second coordinate group G2 is (280, 215). The end point coordinate of the second coordinate group G2 is (312, 207). The generating unit 24 calculates an inter-start point coordinate distance and an inter-end point coordinate distance from the start point coordinates and the end point coordinates. The generating unit 24 calculates the distances using only X coordinates.

The inter-start point coordinate distance between the coordinate (202, 205) of the first coordinate G1a and the start point coordinate (280, 215) of the second coordinate group G2 is calculated as 280−202=78. The inter-end point coordinate distance between the coordinate (202, 205) of the first coordinate G1a and the end point coordinate (312, 207) of the second coordinate group G2 is calculated as 312−202=110. Therefore, there is a relation of the inter-start point coordinate distance<the inter-end point coordinate distance. That is, it is recognized that the operation by the user is the pinch-out operation fixed at one point.

The generating unit 24 determines a correcting method referring to the classification table 25 shown in FIG. 11. In the embodiment, the number of designated regions is “1”, the number of input coordinates is “2”, the distance is “increased (fixed at one point)”, and the positional relation is “partially included”. Consequently, when the classification table 25 is referred to, the correcting method is determined as the enlargement.

As shown in FIG. 48A, the generating unit 24 enlarges the one designated region ra53 on the basis of the correcting method determined in step S191 and generates the one corrected region r56 (step S192).

FIG. 50 is a schematic view illustrating a screen of the image processing apparatus according to the fifth embodiment.

As shown in FIG. 50, in the first display region 261, the image 35, the plurality of image regions r51, r52, r54, and r55, and the corrected region r56 are displayed. The plurality of image regions r51, r52, r54, and r55, and the corrected region r56 are indicated by frame lines or the like surrounding the character strings to enable the user to visually recognize the plurality of image regions r51, r52, r54, and r55, and the corrected region r56. In the second display region 262, the name display field 262a, the number display field 262b, and the date and time display field 262c are displayed. In FIG. 50, the number display field 262b is selected. Therefore, in the number display field 262b, the character string c53 and the character string c56 of the corrected region r56 are displayed. Note that the character string c53 and the character string c56 are, for example, character data read by carrying out OCR (Optical Character Recognition) on the corrected region r56. The character strings c53 and c56 may be image data obtained by segmenting the corrected region r56 from the image 35.

The display control unit 27 (FIG. 39) may change the character strings of the corrected region r56 according to a change in the coordinate information Cd (FIG. 44B). That is, it is possible to perform more intuitive operation by changing display content in association with a result of correction by touch operation or the like by the user. In an example shown in FIG. 50, display content of the number display field 262b changes according to the touch operation or the like by the user. Note that the correction is not limited to the enlargement. For example, in the case of combination, division, and reduction, as in the case of the enlargement, it is possible to change display content in association with a result of correction by touch operation or the like by the user.

The image processing apparatus 114 according to the embodiment detects a plurality of image regions serving as reading regions from an image. The image processing apparatus 114 corrects, according to the operation (pinch-out fixed at one point, etc.) by the user, image regions where characters are excessive or insufficient and desired character strings are not formed among the plurality of image regions and generates image regions composed of the desired character strings. Consequently, even in the case of a character string in which a plurality of words are not linearly arranged, a character string in which a plurality of words are complicatedly arranged, and the like, it is possible to efficiently read characters with simple operation.

### Sixth Embodiment

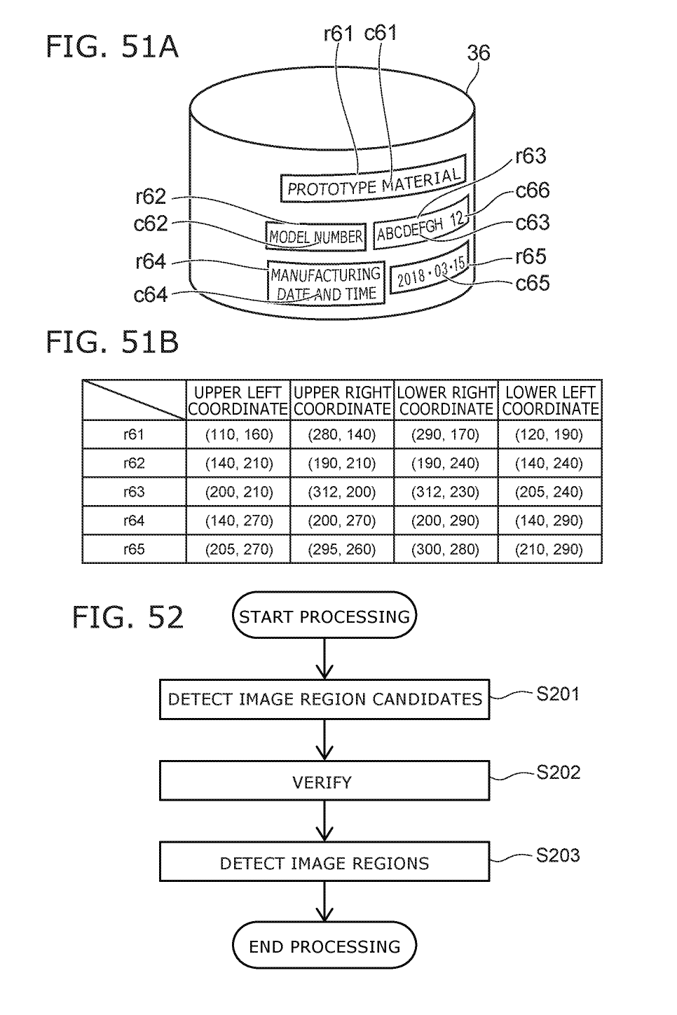

FIG. 51A and FIG. 51B are diagrams illustrating the operation of the detecting unit 21 according to a sixth embodiment.

FIG. 51A is a schematic view illustrating an image representing a detection result of the detecting unit 21.

FIG. 51B is a diagram illustrating coordinate data representing the detection result of the detecting unit 21.

The detecting unit 21 detects a plurality of image regions concerning a plurality of character strings from an image. In the embodiment, as shown in FIG. 51A, the detecting unit 21 detects a plurality of image regions r61 to r65 concerning a plurality of character strings c61 to c65 from an image 36. The respective plurality of image regions r61 to r65 are regions set as reading targets of character strings. The respective plurality of image regions r61 to r65 are illustrated as rectangular regions. The plurality of image regions r61 to r65 may be indicated by frame lines or the like surrounding character strings to enable a user to visually recognize the plurality of image regions r61 to r65 on a screen.

As shown in FIG. 51B, concerning the respective plurality of image regions r61 to r65, upper left coordinates, upper right coordinates, lower right coordinates, and lower right coordinates are detected. Note that, in the example, a coordinate of the image 36 is represented by an XY coordinate with an upper left corner of the image 36 set as a reference (0, 0). An X coordinate is a coordinate in a lateral direction of the image 36 and is represented, for example, in a range of 0 to 400 from the left to the right. A Y coordinate is a coordinate in a longitudinal direction of the image 36 and is represented, for example, in a range of 0 to 300 from up to down.

FIG. 52 is a flowchart for describing an operation example of the detecting unit 21 according to the sixth embodiment.

As shown in FIG. 52, the detecting unit 21 detects a plurality of image region candidates from the image 36 (step S201). The respective plurality of image region candidates include character string candidates. The detecting unit 21 analyzes the image 36 and detects the sizes and the positions of respective character candidates configuring the character string candidates. Specifically, for example, there is a method of generating pyramid images having various resolutions with respect to an analysis target image and identifying whether rectangles having a fixed size obtained by segmenting the pyramid images in a licking manner are character candidates. As feature values used for the identification, for example, Joint Haar-like features are used. As a classifier, for example, an Adaptive Boosting algorithm is used. Consequently, it is possible to detect image region candidates at high speed.

The detecting unit 21 verifies whether the image region candidates detected in step S201 include true characters (step S202). For example, there is a method of discarding image region candidates not determined as characters using a classifier such as a Support Vector Machine.

The detecting unit 21 sets, as a character string, a combination of the image region candidates arranged side by side as one character string candidate among the image region candidates not discarded in step S202 and detects an image region including the character string (step S203). Specifically, the detecting unit 21 votes on a (θ-ρ) space representing line parameters using a method such as Hough transform and determines, as a character string, a set of character candidates (a character string candidate) configuring line parameters of voting frequencies.

In this way, the plurality of image regions r61 to r65 concerning the plurality of character strings c61 to c65 are detected from the image 36.

As shown in FIG. 51A, the character string c63 corresponds to one model number. The character string c66 is unrelated to a model number. However, the character string c66 is detected as an image region and set as a reading target. Therefore, it is desired to reduce the size of the image region r63, exclude the character string c66, and include only the character string c63 in one image region. The size of the image region r63 is reduced by carrying out processing described below.

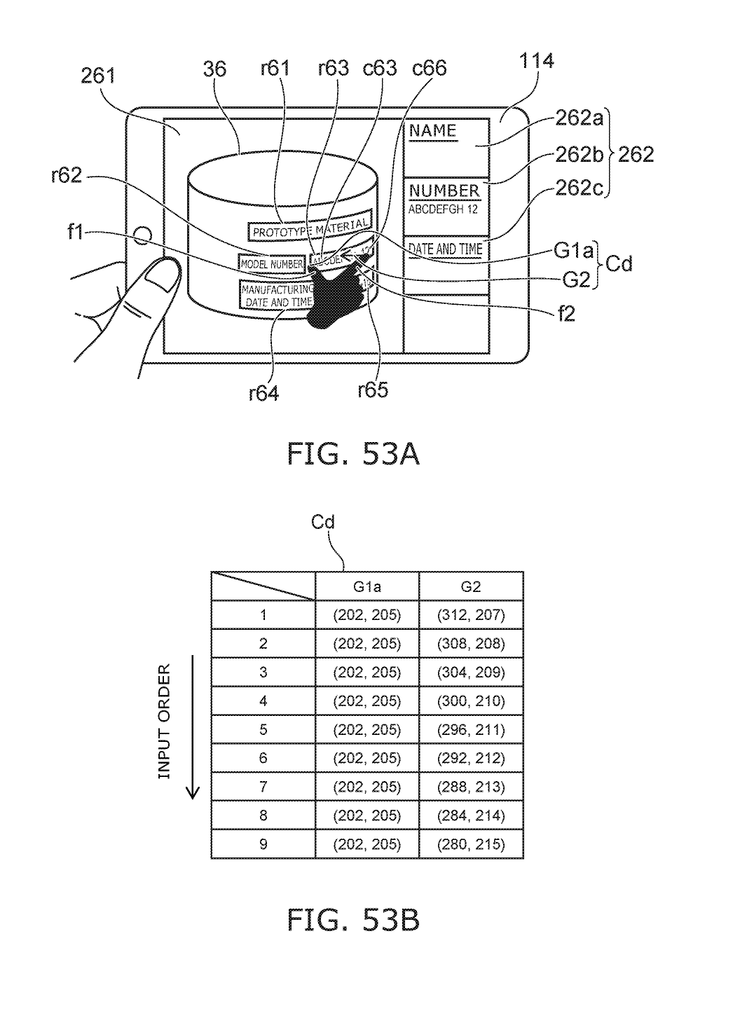

FIG. 53A and FIG. 53B are diagrams illustrating the operation of the receiving unit 22 according to the sixth embodiment.

FIG. 53A is a schematic view illustrating a coordinate input screen for an input to the receiving unit 22.

FIG. 53B is a diagram illustrating coordinate data representing a result of the input to the receiving unit 22.

In the example, the image 36 is displayed on a screen of an image processing apparatus 115. The image processing apparatus 115 includes, for example, a touch panel that enables touch operation on the screen.

The receiving unit 22 receives an input of coordinate information concerning coordinates in an image. In the embodiment, as shown in FIG. 53A, the user fixes the finger f1 and moves the finger f2 with respect to the image 36 displayed on the screen, performs pinch-in operation fixed at one point, and inputs the coordinate information Cd. The pinch-in operation fixed at one point is an operation method for fixing one of the two fingers f1 and f2 in contact with the screen and moves the other finger to reduce the distance between the two fingers f1 and f2. The coordinate information Cd includes the first coordinate G1a and the second coordinate group G2. The first coordinate G1a is one coordinate designated in the image 36. The second coordinate group G2 includes another plurality of coordinates continuously designated in the image 36. The first coordinate G1a corresponds to a fixed position of the finger f1. The other plurality of coordinates of the second coordinate group G2 correspond to a track of the finger f2.

As shown in FIG. 53B, as the first coordinate G1a, for example, a plurality of same coordinates (202, 205) are continuously input. The second coordinate group G2 includes, for example, in an input order, a plurality of coordinates (312, 207), (308, 208), (304, 209), (300, 210), (296, 211), (292, 212), (288, 213), (284, 214), and (280, 215). A start point coordinate of the second coordinate group G2 is (312, 207). An end point coordinate of the second coordinate group G2 is (280, 215).

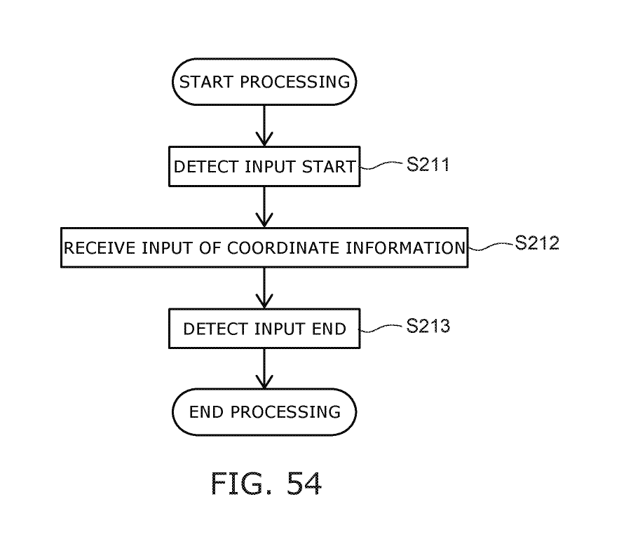

FIG. 54 is a flowchart for describing an operation example of the receiving unit 22 according to the sixth embodiment.

As shown in FIG. 54, the receiving unit 22 detects a trigger of a reception start of a coordinate input (step S211). For example, as shown in FIG. 53A and FIG. 53B, when the receiving unit 22 is configured to receive an input from the touch panel, the receiving unit 22 detects an event such as touch-down as the trigger. Consequently, the receiving unit 22 starts the reception of the coordinate input.

The receiving unit 22 receives an input of coordinate information according to operation by the user (step S212). In FIG. 53A and FIG. 53B, the pinch-in operation fixed at one point is illustrated. Note that, instead of the touch operation, the user may input coordinate information using a pointing device such as a mouse.

As shown in FIG. 53A, in the first display region 261, the image 36 and the plurality of image regions r61 to r65 are displayed. In the example, the image region r63 is designated by touch operation by the user. In this case, the number display field 262b corresponding to the image region r63 is selected. In the number display field 262b, the character string c63 and the character string c66 of the image region r63 are displayed.

The receiving unit 22 detects a trigger of a reception end of the coordinate input (step S213). For example, the receiving unit 22 detects an event such as touch-up as the trigger. Consequently, the receiving unit 22 ends the reception of the coordinate input.

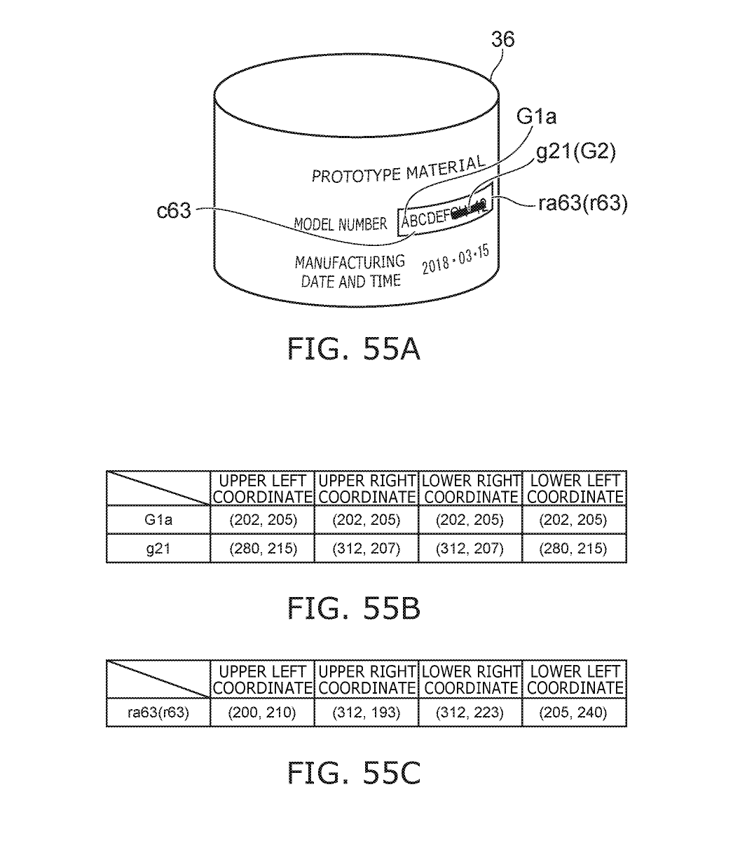

FIG. 55A to FIG. 55C are diagrams illustrating the operation of the extracting unit 23 according to the sixth embodiment.

FIG. 55A is a schematic view illustrating an image representing coordinate regions corresponding to the first coordinate G1a and the second coordinate group G2.

FIG. 55B is a diagram illustrating coordinate data representing the coordinate regions corresponding to the first coordinate G1a and the second coordinate group G2.

FIG. 55C is a diagram illustrating coordinate data representing an extraction result of the extracting unit 23.

The extracting unit 23 extracts, out of a plurality of image regions, designated regions designated by coordinate information. In the embodiment, as shown in FIG. 55A, one designated region ra63 is extracted out of the plurality of image regions r61 to r65 according to the first coordinate G1a and the coordinate region g21. The coordinate region g21 corresponds to the second coordinate group G2. The coordinate region g21 is configured by, for example, a bounding rectangle including coordinates of the second coordinate group G2. The extracting unit 23 extracts, as designated regions, for example, image regions overlapping the first coordinate G1a and the coordinate region g21 among the plurality of image regions r61 to r65.

As shown in FIG. 55B, concerning the coordinate region g21, an upper left coordinate, an upper right coordinate, a lower right coordinate, and a lower right coordinate are calculated. Note that the respective coordinates of the coordinate region g21 can be calculated from the coordinate information Cd (the second coordinate group G2) shown in FIG. 53B.

As shown in FIG. 55C, concerning the designated region ra63, an upper left coordinate, an upper right coordinate, a lower right coordinate, and a lower right coordinate are detected. The coordinates of the designated region ra63 are the same as the coordinates of the image region r63. In the embodiment, the size of the designated region ra63 is reduced to exclude the character string c56.

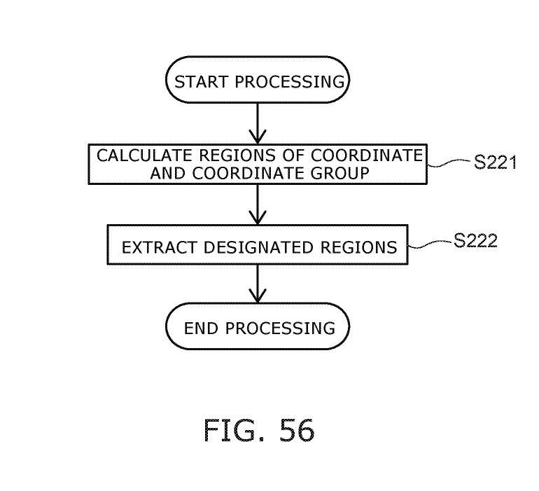

FIG. 56 is a flowchart for describing an operation example of the extracting unit 23 according to the sixth embodiment.

As shown in FIG. 56, the extracting unit 23 calculates coordinate regions respectively corresponding to the first coordinate G1a and the second coordinate group G2 (step S221). As shown in FIG. 55A, the coordinate region g21 corresponds to the second coordinate group G2. The coordinate region g21 is configured by, for example, a bounding rectangle including coordinates of the second coordinate group G2.

The extracting unit 23 extracts, out of the image regions r61 to r65, the one designated region ra63 designated by the first coordinate G1a and the coordinate region g21 (step S222). For example, the extracting unit 23 extracts, as designated regions, image regions overlapping the first coordinate G1a and the coordinate region g21 among the plurality of image regions r61 to r65. As shown in FIG. 55A and FIG. 55C, the image region r63 is extracted as the designated region ra63 out of the plurality of image regions r61 to r65.

In the embodiment, the coordinate region g21 is designated to exclude the character string c66. For example, the one designated region ra63 is reduced to the end point coordinate of the coordinate region g21. The end point coordinate of the coordinate region g21 corresponds to the last character of the character string c63.

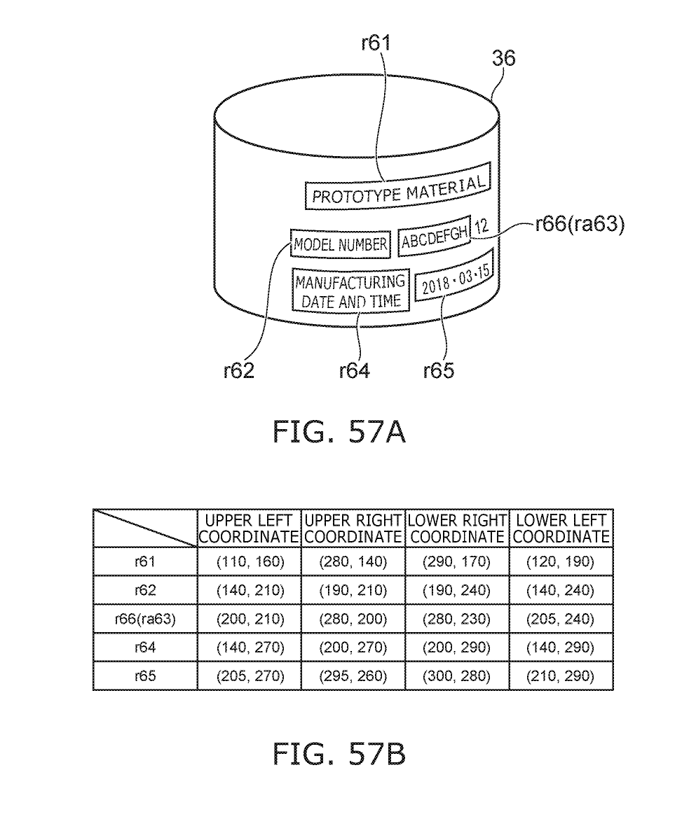

FIG. 57A and FIG. 57B are diagrams illustrating the operation of the generating unit 24 according to the sixth embodiment.

FIG. 57A is a schematic view illustrating an image representing a generation result of the generating unit 24.

FIG. 57B is a diagram illustrating coordinate data representing the generation result of the generating unit 24.

The generating unit 24 generates, on the basis of coordinate information, corrected regions obtained by correcting at least one of the number and the size of designated regions. In the embodiment, as shown in FIG. 57A, the generating unit 24 reduces the one designated region ra63 on the basis of the first coordinate G1a and the second coordinate group G2 and generates one corrected region r66. The designated region ra63 after the reduction does not include the character string c66. The corrected region r66 is configured as, for example, a bounding rectangle including coordinates of the designated region ra63 after the reduction.

As shown in FIG. 57B, an upper left coordinate, an upper right coordinate, a lower right coordinate, and a lower left coordinate of the corrected region r66 are detected. The upper left coordinate, the upper right coordinate, the lower right coordinate, and the lower left coordinate are respectively (200, 210), (280, 200), (280, 230), and (205, 240).

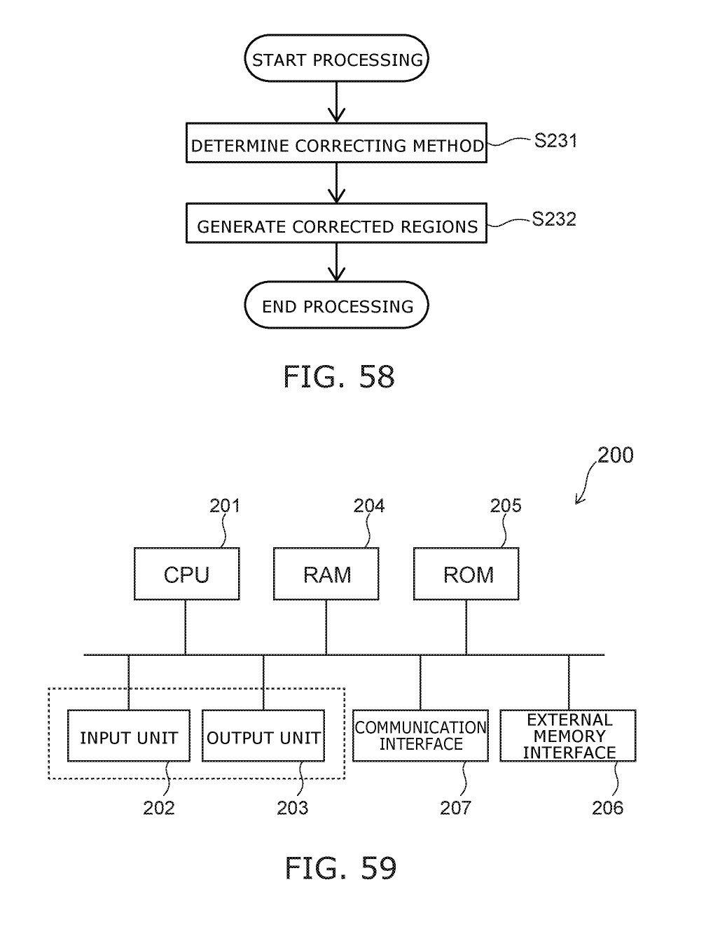

FIG. 58 is a flowchart for describing an operation example of the generating unit 24 according to the sixth embodiment.

As shown in FIG. 58, the generating unit 24 determines a correcting method using the classification table 25 (step S231). As described above, the coordinate of the first coordinate G1a is (202, 205). The start point coordinate of the second coordinate group G2 is (312, 207). The end point coordinate of the second coordinate group G2 is (280, 215). The generating unit 24 calculates an inter-start point coordinate distance and an inter-end point coordinate distance from the start point coordinates and the end point coordinates. The generating unit 24 calculates the distances using only X coordinates.

The inter-start point coordinate distance between the coordinate (202, 205) of the first coordinate G1a and the start point coordinate (312, 207) of the second coordinate group G2 is calculated as 312−202=110. The inter-end point coordinate distance between the coordinate (202, 205) of the first coordinate G1a and the end point coordinate (280, 215) of the second coordinate group G2 is calculated as 280−202=78. Therefore, there is a relation of the inter-start point coordinate distance>the inter-end point coordinate distance. That is, it is recognized that the operation by the user is the pinch-in operation fixed at one point.

The generating unit 24 determines a correcting method referring to the classification table 25 shown in FIG. 11. In the embodiment, the number of designated regions is “1”, the number of input coordinates is “2”, the distance is “reduced (fixed at one point)”, and the positional relation is “partially included”. Consequently, when the classification table 25 is referred to, the correcting method is determined as the reduction.

As shown in FIG. 57A, the generating unit 24 reduces the one designated region ra63 on the basis of the correcting method determined in step S231 and generates the one corrected region r66 (step S232).

The image processing apparatus 115 according to the embodiment detects a plurality of image regions serving as reading regions from an image. The image processing apparatus 115 corrects, according to the operation (pinch-in fixed at one point, etc.) by the users, image regions where characters are excessive or insufficient and desired character strings are not formed among the plurality of image regions and generates image regions composed of the desired character strings. Consequently, even in the case of a character string in which a plurality of words are not linearly arranged, a character string in which a plurality of words are complicatedly arranged, and the like, it is possible to efficiently read characters with simple operation.

### Seventh Embodiment

FIG. 59 is a block diagram illustrating an image processing apparatus according to a seventh embodiment.

An image processing apparatus 200 according to the embodiment can be realized by various devices such as a general-purpose computer of a desktop type or a laptop type, a portable general-purpose computer, other portable information apparatuses, an information apparatus including an image pickup device, a smartphone, and other information processing apparatuses.

As shown in FIG. 59, the image processing apparatus 200 of the embodiment includes, as a configuration example of hardware, a CPU 201, an input unit 202, an output unit 203, a RAM 204, a ROM 205, an external memory interface 206, and a communication interface 207.

The instructions described in the processing procedures described in the embodiments can be executed on the basis of a program, which is software. A general-purpose computer system stores the program in advance and reads the program, whereby it is possible to obtain effects same as the effects by the image processing apparatuses of the embodiments described above. The instructions described in the embodiments are recorded in a magnetic disk (a flexible disk, a hard disk, etc.), an optical disk (a CD-ROM, a CD-R, a CD-RW, a DVD-ROM, a DVD±R, a DVD±RW, etc.), a semiconductor memory, or a recording medium similar to the magnetic disk, the optical disk, or the semiconductor memory as a program that can be executed by a computer. A storage form of the program may be any form as long as the program is stored in a recording medium readable by the computer or an integrated system. If the computer reads the program from the recording medium and causes a CPU to execute the instructions described in the program on the basis of the program, the computer can realize operations same as the operations of the image processing apparatuses of the embodiments. Naturally, when the computer acquires the program or reads the program, the computer may acquire or read the program through a network.

For example, an OS (operating system) running on the computer on the basis of the instructions of the program installed in the computer or the integrated system from the recording medium, database management software, an MW (middleware) operating on the network or the like may execute a part of the kinds of processing for realizing the embodiments.

Further, the recording medium in the embodiments is not limited to a recording medium independent from the computer or the integrated system and includes a recording medium in which the program transmitted by a LAN, the Internet, or the like is downloaded and stored or temporarily stored. The recording medium is not limited to one recording medium. When the processing in the embodiments is executed from a plurality of recording media, the recording media are included in the recording medium in the embodiments. The configuration of the recording medium may be any configuration.

Note that the computer or the integrated system in the embodiments is a computer or an integrated system for executing the kinds of processing in the embodiments on the basis of the program stored in the recording medium. The computer or the integrated system may be any configuration such as an apparatus composed of one of a personal computer, a microcomputer, and the like or a system in which a plurality of apparatuses are connected by a network.

The computer in the embodiments is not limited to the personal computer and includes an arithmetic processing unit included in an information processing apparatus, a microcomputer, and the like. The computer is a general term of devices and apparatuses capable of realizing the functions in the embodiments according to the program.

According to the embodiments, it is possible to provide an image processing apparatus, an image processing method, and an image processing program capable of efficiently reading characters with simple operation.

Hereinabove, exemplary embodiments of the invention are described with reference to specific examples. However, the embodiments of the invention are not limited to these specific examples. For example, one skilled in the art may similarly practice the invention by appropriately selecting specific configurations of components such as acquiring units, processing units, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all image processing apparatuses, image processing methods, and image processing programs practicable by an appropriate design modification by one skilled in the art based on the image processing apparatuses, image processing methods, and image processing programs described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An image processing apparatus comprising:
an acquiring unit that acquires an image including a plurality of character strings; and
a processing unit, the processing unit carrying out:
a detecting operation for detecting a plurality of image regions concerning the plurality of character strings from the image;
a receiving operation for receiving an input of coordinate information concerning coordinates in the image;
an extracting operation for extracting, out of the plurality of image regions, designated regions designated by the coordinate information; and
a generating operation for generating, on the basis of the coordinate information, corrected regions obtained by correcting at least one of a number and a size of the designated regions.

2. The apparatus according to claim 1, wherein
the coordinate information relates to a first coordinate group including a plurality of coordinates continuously designated in the image and a second coordinate group including another plurality of coordinates continuously designated in the image,
a plurality of the designated regions are extracted out of the plurality of image regions according to the first coordinate group and the second coordinate group,
a direction from a first start point coordinate to a first end point coordinate of the first coordinate group is opposite to a direction from a second start point coordinate to a second end point coordinate of the second coordinate group, and a distance between the first start point coordinate and the second start point coordinate is longer than a distance between the first end point coordinate and the second end point coordinate, and
the correction includes combining the plurality of designated regions.

3. The apparatus according to claim 1, wherein
the coordinate information relates to a first coordinate group including a plurality of coordinates continuously designated in the image and a second coordinate group including another plurality of coordinates continuously designated in the image,
a singularity of the designated region is extracted out of the plurality of image regions according to the first coordinate group and the second coordinate group,
a direction from a first start point coordinate to a first end point coordinate of the first coordinate group is opposite to a direction from a second start point coordinate to a second end point coordinate of the second coordinate group, and a distance between the first start point coordinate and the second start point coordinate is shorter than a distance between the first end point coordinate and the second end point coordinate, and
the correction includes dividing the one designated region.

4. The apparatus according to claim 3, wherein
the detecting operation further includes detecting an attribute for each of characters of the character strings included in the respective plurality of image regions, and
the correction further includes dividing the one designated region on the basis of the attribute.

5. The apparatus according to claim 4, wherein
the attribute includes an inter-character distance, and
the one designated region is divided between two characters, the inter-character distance of which is largest.

6. The apparatus according to claim 4, wherein
the attribute includes at least one of a character color, a character size, and an aspect ratio, and
the one designated region is divided between two characters different in at least one of the character color, the character size, and the aspect ratio.

7. The apparatus according to claim 4, wherein the detecting operation further includes setting rectangular regions surrounding a respective plurality of characters of the character strings.

8. The apparatus according to claim 1, wherein
the detecting operation further includes detecting an attribute for each of characters of the character strings included in the respective plurality of image regions,
the coordinate information relates to a first coordinate group including a plurality of coordinates continuously designated in the image and a second coordinate group including another plurality of coordinates continuously designated in the image,
a pair of the designated regions is extracted out of the plurality of image regions according to the first coordinate group and the second coordinate group,
one of the two designated regions includes a first character string including a plurality of characters, the attribute of which is a first attribute, and a second character string including a plurality of characters, the attribute of which is a second attribute,
another of the two designated regions includes a third character string including a plurality of characters, the attribute of which is the second attribute,
a direction from a first start point coordinate to a first end point coordinate of the first coordinate group is opposite to a direction from a second start point coordinate to a second end point coordinate of the second coordinate group, and a distance between the first start point coordinate and the second start point coordinate is longer than a distance between the first end point coordinate and the second end point coordinate, and
the correction includes combining the second character string having the second attribute and the third character string having the second attribute and dividing the first character string having the first attribute and the second character string having the second attribute.

9. The apparatus according to claim 8, wherein the attribute includes at least one of a character color, a character size, and an aspect ratio.

10. The apparatus according to claim 1, wherein
the coordinate information relates to a first coordinate designated in the image and a second coordinate group including another plurality of coordinates continuously designated in the image,
a singularity of the designated region is extracted out of the plurality of image regions according to the first coordinate and the second coordinate group,
a distance between the first coordinate and a start point coordinate of the second coordinate group is shorter than a distance between the first coordinate and an end point coordinate of the second coordinate group, and
the correction includes increasing a size of the one designated region.

11. The apparatus according to claim 10, wherein the correction further includes enlarging the one designated region to the end point coordinate of the second coordinate group.

12. The apparatus according to claim 1, wherein
the coordinate information relates to a first coordinate designated in the image and a second coordinate group including another plurality of coordinates continuously designated in the image,
a singularity of the designated region is extracted out of the plurality of image regions according to the first coordinate and the second coordinate group,
a distance between the first coordinate and a start point coordinate of the second coordinate group is longer than a distance between the first coordinate and an end point coordinate of the second coordinate group, and
the correction includes reducing a size of the one designated region.

13. The apparatus according to claim 12, wherein the correction further includes reducing the one designated region to the end point position of the second coordinate group.

14. The apparatus according to claim 1, wherein
the coordinate information relates to a first coordinate group including a plurality of coordinates continuously designated in the image,
a pair of the designated regions is extracted out of the plurality of image regions according to the first coordinate group,
a start point coordinate of the first coordinate group is located at a rear end portion of one region of the two designated regions,
an end point coordinate of the first coordinate group is located at a front end portion of anther region of the two designated regions, and
the correction includes combining the two designated regions.

15. The apparatus according to claim 1, further comprising:
a display unit including a first display region for displaying the image and the plurality of first image regions and a second display region for displaying character strings of the corrected regions; and
a display control unit that controls display of the display unit, the display control unit changing the character strings of the corrected regions according to a change in the coordinate information.

16. The apparatus according to claim 15, further comprising a touch panel provided in the display unit, wherein
the receiving operation includes receiving an input of the coordinate information via the touch panel.

17. An image processing method comprising:
acquiring an image including a plurality of character strings;
detecting a plurality of image regions concerning the plurality of character strings from the image;
receiving an input of coordinate information concerning coordinates in the image;
extracting, out of the plurality of image regions, designated regions designated by the coordinate information; and
generating, on the basis of the coordinate information, corrected regions obtained by correcting at least one of a number and a size of the designated regions.

18. An image processing program for causing a computer to execute:
a process for acquiring an image including a plurality of character strings;
a process for detecting a plurality of image regions concerning the plurality of character strings from the image;
a process for receiving an input of coordinate information concerning coordinates in the image;
a process for extracting, out of the plurality of image regions, designated regions designated by the coordinate information; and
a process for generating, on the basis of the coordinate information, corrected regions obtained by correcting at least one of a number and a size of the designated regions.
